(19) United States
(12) Patent Application Publication
(10) Pub. No.: US 2026/0261549 A1
(43) Pub. Date: Sep. 3, 2026

(54) Credential Data Replication in Distributed Cloud Environments

(71) Applicant: Oracle International Corporation, Redwood Shores, CA (US)

(72) Inventors: Jagrut R. Desai, Shrewsbury, MA (US); Anuj Kaushal, Noida (IN); Ankur Prakash, Banagalore (IN); Preyam Rao, Bangalore (IN); Srimant Misra, Bangalore (IN)

(73) Assignee: Oracle International Corporation, Redwood Shores, CA (US)

(21) Appl. No.: 19/067,807

(22) Filed: Feb. 28, 2025

(51) Int. Cl. H04L 9/40

(52) U.S. Cl. CPC H04L 63/08

(57) ABSTRACT

Computer-implemented techniques manage credential data across multiple cloud regions by implementing replication and failover mechanisms. The techniques store different types of credential data, such as authentication tokens and encryption keys, in separate storage systems within a primary cloud region. Changes to credential data trigger replication processes to additional cloud regions with destination regions determined by associated tenant identifiers. During replication, the credential data undergoes transformation to meet region-specific requirements before storage in corresponding systems. The techniques enable failover capabilities when a primary region becomes unavailable, allowing operations to transition to a secondary region including synchronized credential data. This synchronization maintains operational continuity while preserving security and access control policies. The architecture ensures consistent credential management across distributed cloud environments.

### TECHNICAL FIELD

This disclosure relates generally to credential replication. More particularly, the disclosure relates to managing credential data across distributed cloud environments while ensuring data availability and service continuity.

### BACKGROUND

Organizations rely on credential data to control access to computing resources and protect sensitive information. Credential data includes authentication tokens, certificates, passwords, encryption keys, and access control rules that enable secure operations. Managing credential data requires robust storage systems and security protocols to prevent unauthorized access while ensuring legitimate users can efficiently interact with protected resources.

Modern enterprises increasingly deploy applications and services across distributed cloud environments. These distributed environments span multiple geographic regions to improve performance, comply with data residency requirements, and serve a global user base. Cloud regions represent distinct physical locations including data centers and computing infrastructure. Applications running in distributed cloud environments maintain high availability and continuous operations despite potential system failures or regional outages.

The management of credential data in distributed cloud environments presents significant challenges. When credential data becomes unavailable in one cloud region, applications may experience authentication failures and service disruptions. Organizations need reliable mechanisms to maintain access to credential data across cloud regions. The technical complexity increases when different cloud regions implement varying security requirements and data formats. System architects address these challenges while ensuring consistent security policies and minimizing operational impact on users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for synchronizing credential data between cloud regions while enabling failover capabilities and maintaining operational continuity for tenant services according to one or more embodiments;

FIG. 2 illustrates a system and method for designating a leader service instance and storing leader information in a replicated database-backed cache across cloud regions according to one or more embodiments;

FIG. 3 illustrates a system and method for storing static credentials in hardware secure storage and ephemeral credentials in a distributed cache within a cloud region according to one or more embodiments;

FIG. 4 illustrates a system and method for handling credential synchronization errors using a dead letter queue and automated recovery based on subsequent successful updates according to one or more embodiments;

FIG. 5 illustrates a system and method for detecting credential changes using distributed caching, polling at intervals, and verifying synchronization through state comparison according to one or more embodiments;

FIG. 6 illustrates a system and method for bi-directional synchronization between cloud regions using shared data storage instances serving multiple tenants with designated primary and secondary regions according to one or more embodiments;

FIG. 7 illustrates a system and method for storing and synchronizing static, ephemeral, and in-memory credentials across multiple cloud regions using distinct storage systems and replication mechanisms according to one or more embodiments;

FIG. 8 illustrates a system and method for storing different types of authentication tokens in secure hardware or distributed cache storage based on update frequency characteristics according to one or more embodiments;

FIG. 9 illustrates a system and method for synchronizing credential data between cloud regions and generating in-memory tokens from persistent credentials after failover operations according to one or more embodiments;

FIG. 10 illustrates a system and method for detecting credential data changes through polling a change log and initiating synchronization based on tenant identifiers in a cloud region according to one or more embodiments;

FIG. 11 illustrates a system and method for synchronizing credential data across multiple storage tiers using different replication mechanisms between cloud regions according to one or more embodiments;

FIG. 12 illustrates a system and method for switching network traffic between cloud regions during failover operations using synchronized credential data and request processing according to one or more embodiments; and

FIG. 13 is a block diagram that illustrates an example computer system upon which one or more embodiments are implemented.

### DETAILED DESCRIPTION

In the following detailed description, for the purposes of explanation, numerous specific details are set forth to aid understanding of one or more embodiments of the present disclosure. In some instances, one or embodiments of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In one or more embodiments, well-known structures and devices are shown in the figures in block diagram form to avoid unnecessarily obscuring the embodiment.
1. GENERAL OVERVIEW
2. CREDENTIAL DATA REPLICATION IN DISTRIBUTED CLOUD ENVIRONMENTS
3. EXAMPLE EMBODIMENT
4. PRACTICAL APPLICATIONS; ADVANTAGES; IMPROVEMENTS
5. COMPUTER NETWORKS AND CLOUD NETWORKS
6. HARDWARE OVERVIEW
7. MISCELLANEOUS; EXTENSIONS

### 1. GENERAL OVERVIEW

One or more embodiments provide techniques for managing credential data across cloud regions. The techniques enable replication of credential data between cloud regions while maintaining data consistency and operational continuity. A first cloud region receives and stores credential data associated with tenant identifiers. The credential data may be stored in different storage systems based on the type of credential data. For example, authentication tokens may be stored in a first storage system while encryption keys may be stored in a second storage system.

In one or more embodiments, changes to credential data in a first cloud region trigger replication to additional cloud regions. The additional cloud regions for replication may be determined based on tenant identifiers associated with the credential data. The credential data undergoes transformation during replication to meet specific requirements of destination cloud regions. The transformed credential data is then stored in corresponding storage systems of the destination cloud regions.

One or more embodiments enable failover capabilities between cloud regions. When a first cloud region becomes unavailable, operations associated with tenant identifiers can fail over to a second cloud region. The second cloud region maintains synchronized copies of credential data, allowing continuous operation of services that depend on the credential data. The synchronized credential data enables seamless transition of operations between cloud regions while maintaining security and access control policies.

One or more embodiments described in this Specification and/or recited in the claims may not be included in the General Overview section.

One or more embodiments will now be described with respect to the figures. In one or more embodiments, a system depicted in a figure may include more or fewer components than the components illustrated in the figure. The components illustrated in the figure may be local to or remote from each other. The components illustrated in the figure may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in Section 5, titled “Computer Networks and Cloud Networks.” In one or more embodiments, one or more operations of method illustrated in a figure may be modified, rearranged, or omitted. Accordingly, the particular sequence of operations illustrated in a figure should not be construed as limiting the scope of one or more embodiments.

### 2.0 CREDENTIAL DATA REPLICATION IN DISTRIBUTED CLOUD ENVIRONMENTS

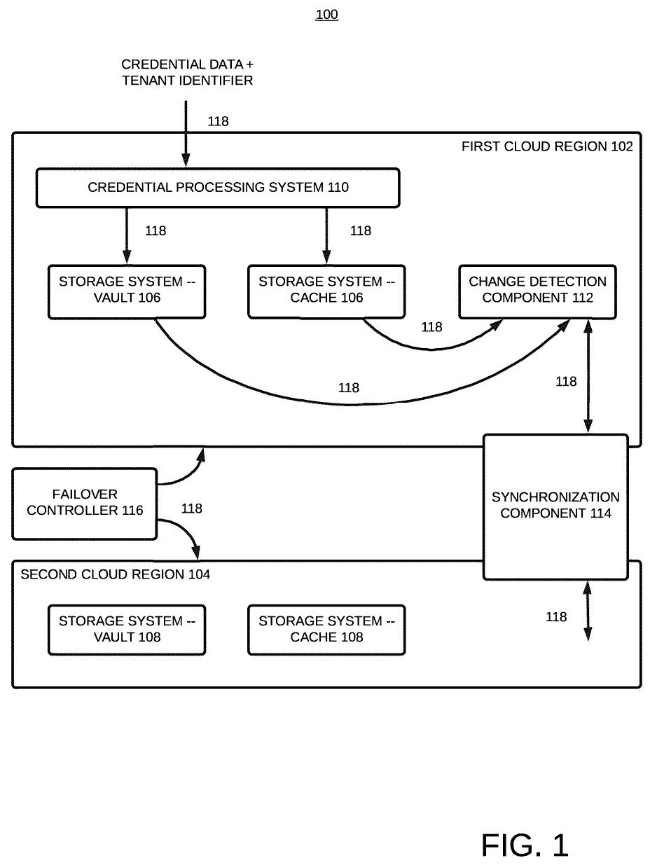

FIG. 1 illustrates a system 100 for synchronizing credential data between cloud regions while enabling failover capabilities and maintaining operational continuity for tenant services according to one or more embodiments.

The system 100 manages credential data synchronization and failover across multiple cloud regions. The system 100 receives credential data at a first cloud region, where the credential data associates with a specific tenant identifier. Based on the type of credential data received, the system stores this data in appropriate storage systems within the first cloud region.

As used herein, the term “region” refers to a geographically distinct and independent location that houses a collection of data centers, often organized into availability zones and further subdivided into cells within those zones or data centers, provided by the cloud service provider. Each region is physically separated from other regions, offering fault tolerance and disaster recovery capabilities. A region provides a set of cloud services and resources, such as compute, storage, and networking, that are accessible to tenants within that region. The use of multiple regions allows for geographic redundancy and enables customers to deploy applications closer to their users, reducing latency and improving performance. They also provide a way to meet data sovereignty and compliance requirements.

The system 100 actively monitors for any changes to the credential data in the first cloud region. When a change occurs, the system determines a second cloud region for replication using the tenant identifier. The system then initiates a synchronization process between the first and second cloud regions. During synchronization, the system retrieves the credential data from the storage systems in the first cloud region and transforms the data to meet the specific requirements of the second cloud region.

The system 100 stores the transformed credential data in corresponding storage systems within the second cloud region. This synchronized state enables failover capabilities between the cloud regions. In the event of a failover to the second cloud region, the system maintains continuous operations associated with the tenant identifier by utilizing the synchronized credential data. This approach ensures uninterrupted service delivery despite potential regional disruptions.

First cloud region 102 represents a primary cloud computing environment that serves as the initial point of interaction for handling credential data in a disaster recovery system. The region operates as part of a geographically dispersed, multi-region cloud infrastructure offered by a hyperscale cloud provider. For example, First Cloud Region 102 could be implemented as a physically isolated data center in a specific location, like Sydney, Australia, with the capability to serve multiple (e.g., 512) tenants per cell.

As used herein, the term “cell” refers to a modular and independent unit of deployment and scaling within the cloud infrastructure that represents a subset of the overall cloud region's resources. Each cell is logically isolated from other cells, operating as a self-contained environment with its own compute, storage, and networking resources allocated to serve a specific number of tenants. This architecture enhances fault isolation, ensuring that issues within one cell do not impact the operation of others, and allows for incremental scaling by adding new cells to accommodate growth. Furthermore, cells facilitate staged deployments and updates, minimizing risk and improving the overall manageability of the cloud environment.

As used herein, the term “tenant” refers to an individual customer, organization, or application that utilizes the resources of the cloud environment. In this multi-tenant architecture, each tenant is logically isolated from other tenants, ensuring data security and privacy. A tenant can be thought of as a distinct entity with its own dedicated set of resources within a cell, such as virtual machines, storage, and network configurations, customized according to their specific needs. This isolation prevents tenants from accessing each other's data or impacting each other's performance, providing a secure and independent operating environment within the shared cloud infrastructure.

First cloud region 102 includes multiple storage systems optimized for different types of credentials. For example, the region uses hardware secure vaults for storing sensitive static credentials, like usernames and passwords. The region also employs distributed caches backed by databases for storing ephemeral credentials such as OAuth tokens that require frequent updates.

As used herein, a “hardware secure vault” (sometimes referred to as a “hardware security module” or “HSM”) is a dedicated physical device designed to safeguard and manage cryptographic keys and perform cryptographic operations. They are computers with hardened security features to protect highly sensitive data, such as cryptographic keys, within a tamper-resistant physical enclosure.

The region acts as the primary instance for designated tenants, receiving and processing their credential data through a secrets manager component. This component segregates credentials across appropriate storage systems based on their characteristics. For instance, when saving a connection with both static credentials and OAuth tokens, First Cloud Region 102 stores them in the secure vault and ephemeral cache, respectively.

The first cloud region 102 maintains a change log to track modifications to credential data, which is useful for replication purposes. The region implements a polling mechanism that checks for changes on a regular interval such as every 30 minutes. When changes are detected, first cloud region 102 initiates synchronization with the paired secondary region. The region ensures data consistency through a double-check mechanism during replication, verifying that no changes occurred during the transfer process.

The polling interval is configurable and can be adjusted based on specific replication requirements. Organizations can set near real-time polling for scenarios demanding minimal replication lag or extend the interval beyond 30 minutes when immediate synchronization is less critical. Additionally, the system supports an event-driven notification mechanism that can complement or replace the polling approach. With event-driven replication, the source region triggers synchronization when one or more credential changes occur, eliminating the latency inherent in periodic polling while potentially reducing system overhead.

In the context of multi-tenant environments, first cloud region 102 uses a shared vault instance to serve multiple tenants rather than maintaining separate vault instances per tenant. This architecture enables efficient resource utilization while maintaining tenant isolation through proper credential segregation and access controls.

The second cloud region 104 represents a geographically distinct cloud computing environment that serves as a failover destination for credential data replication. This scenario could be exemplified by a secondary data center location, like Melbourne, Australia, serving as a failover site for a primary region in Sydney. The Second Cloud Region 104 maintains corresponding storage systems that mirror those in the first cloud region, including hardware secure vaults for static credentials and distributed caches for ephemeral tokens.

The second cloud region 104 determination occurs based on the tenant identifier, for each tenant has a predefined primary-secondary relationship between regions. This region serves as part of a disaster recovery configuration, where the region can become the active instance if the primary region experiences an outage. The Second Cloud Region 104 receives transformed credential data that has been adapted to meet specific requirements such as using region-specific encryption keys for vault storage.

The second cloud region 104 participates in a bi-directional synchronization architecture, where the region can serve as either a primary or secondary region depending on tenant configuration. For example, while the region may be the secondary region for some tenants with Region A as primary, the region could simultaneously be the primary region for other tenants who have Region B configured as their primary location. This region maintains exact replicas of connections and associated credentials, ensuring that customer automations can continue operating seamlessly after failover events.

Storage systems 106 and 108 refer to the different types of storage infrastructure used to maintain credential data within each cloud region. These storage systems include hardware secure vaults, distributed caches backed by databases, and volatile memory. The storage systems are based on the characteristics and requirements of different credential types. For example, static credentials, like usernames and passwords, are stored in hardware secure vaults that provide strong security guarantees. Ephemeral credentials, like short-lived access tokens, are stored in distributed caches that are optimized for frequent updates. In-memory storage is used for temporary credential data that needs fast access.

The storage systems work together as part of a hybrid architecture. A secrets manager component intelligently segregates credentials across the appropriate storage systems when connections are saved. For instance, when saving a connection with both static credentials and OAuth tokens, the secrets manager determines which credentials belong in the secure vault versus the ephemeral cache or memory. Each storage system maintains a canonical cross-regional identifier combining tenant ID, instance ID, and connection details to ensure referential integrity.

The storage systems also employ different replication mechanisms based on their characteristics. The distributed cache leverages native database replication technology. The vault storage uses custom API-based replication since the vault lacks native multi-master capabilities. In-memory storage is handled by rebuilding the state in the secondary region based on replicated persistent data. This hybrid approach allows the system to optimize storage and replication based on the specific needs of different credential types while maintaining overall consistency.

The credential processing system 110 represents a cloud-based system for managing and replicating credentials across different cloud regions while maintaining business continuity. The system handles various types of security credentials including static credentials (like usernames and passwords), dynamic credentials (such as OAuth tokens), and certificates.

The system intelligently segregates credentials across multiple storage systems based on their characteristics. For example, the system stores static credentials that rarely change in hardware secure vaults for maximum security, while frequently updated ephemeral tokens are stored in distributed caches optimized for high-frequency updates.

The credential processing system 110 implements a synchronization mechanism that operates on a regular polling interval such as an N (e.g., 30)-minute polling interval. The system maintains a change log to track credential-related actions and uses different replication approaches depending on the credential type. For instance, the system leverages native database replication technology for ephemeral secrets in database-backed caches, while implementing custom replication logic using vault APIs for vault-stored secrets.

The system ensures proper credential transformation during replication through a customer secrets manager component deployed in both primary and secondary regions. This component maintains consistent handling of credential data during storage and retrieval operations. The system also implements a double-check mechanism during replication to verify consistency, placing credentials back in the change secrets cache if any inconsistencies are detected during transfer.

The credential processing system 110 provides support for bi-directional synchronization in a multi-tenant environment, where different tenants can have different primary regions. The system prevents credential conflicts by enforcing a strict primary/secondary relationship for each tenant, ensuring that credential updates for a given tenant occur in their active region.

The change detection component 112 handles monitoring and identifying modifications to credential data within a cloud region's storage systems. This component implements a polling-based mechanism that checks for changes on a regular interval, such as every N (e.g., 30) minutes, and maintains a change log of credential-related actions.

The change detection component 112 tracks changes through a changelog that records credential operations, such as creates, updates, and deletes. For example, when a customer updates an OAuth connection's credentials, the component records the change in the log using a canonical cross-regional identifier that combines the tenant ID, instance ID, and connection details into a unique key.

The component utilizes an in-memory data structure store instead of a distributed, append-only commit log for maintaining the list of changed secrets during each polling period. This approach provides a simpler solution since multiple updates to the same secret result in a single entry rather than maintaining a sequence of change events. When detecting changes, the component examines specific identifiers (computed as a hash of tenant ID and connection details) and operation types in the change log.

The change detection component 112 implements a double-check mechanism to ensure consistency. After identifying changes, the component takes a snapshot of the latest credential state before replication begins. The component then verifies that no additional changes occurred during the transfer process. If changes are detected during this verification, the credential returns to the change secrets cache for another replication attempt. The component removes entries from the change log after confirming the replicated state matches the latest state.

This component works within the system's eventual consistency model, which, in one example implementation, has a defined service level agreement of N (e.g., 30) minutes for cross-region replication. This means the change detection component 112 can identify and queue credential changes within this window to maintain the system's replication guarantees.

Synchronization component 114 represents an element that handles the cross-region replication of credential data in a cloud computing environment. The component implements a bi-directional synchronization mechanism that ensures credential consistency between primary and secondary cloud regions while maintaining tenant isolation.

The synchronization component 114 operates by monitoring changes to credential data through a change log system. For example, in one example implementation, when a customer creates or updates connection credentials in their primary region, the component detects these changes and initiates the synchronization process to the secondary region within a defined service level agreement of N (e.g., 30) minutes. The component handles different types of credentials—storing static credentials like usernames and passwords in a hardware secure vault, while managing ephemeral credentials like OAuth tokens in distributed caches optimized for frequent updates.

The component employs a hybrid synchronization approach including multiple mechanisms. For vault-stored secrets, the component uses custom replication logic through vault APIs since native multi-master replication is not available. For ephemeral secrets in database-backed caches, the component leverages a native, log-based change data capture (CDC) and replication mechanism provided by the underlying database system. This hybrid approach ensures comprehensive synchronization across credential storage systems.

The synchronization component 114 maintains data consistency through a double-check verification process. After initiating replication, the component verifies that no changes occurred during transfer. If changes are detected, the credential is returned to the change secrets cache for another replication attempt. The component removes entries from the change log after confirming the replicated state matches the latest state.

The component supports multi-tenant environments where different tenants can have different primary regions, implementing synchronization across non-colliding paths. While each tenant's credentials flow one way (from their primary to secondary region), the component supports bi-directional replication traffic between regions to accommodate varying tenant configurations. This enables the system to serve multiple tenants per cell while maintaining proper isolation and consistency of credential data.

The failover controller 116 represents a component in a cloud-based disaster recovery system that manages the failover process between cloud regions while ensuring credential data remains synchronized and available. The controller enables business automations to continue operating without interruption when switching from a primary region to a secondary region.

The failover controller 116 handles several aspects of the failover process. The controller works with DNS-level switching to automatically route traffic to the secondary region when a primary region fails. Before failover occurs, the controller ensures necessary application credentials, tokens, and security materials are properly synchronized and active in the secondary region. This includes both static credentials stored in secure vaults and ephemeral tokens kept in distributed caches.

The controller maintains consistency by enforcing a strict primary/secondary relationship for each tenant. The controller ensures that credential updates for a given tenant occur in their active region, preventing conflicts during two-way replication. For example, if a tenant has Region A as primary and Region B as secondary, the controller allows credential updates in Region A until a failover event occurs.

The failover controller 116 supports multiple tenants per cell in a region. The controller manages failover capabilities across geographically distributed data centers, such as between Sydney, Australia and Melbourne, Australia. In one implementation, the controller works within an N (e.g., 30)-minute service level agreement for cross-region replication. This means when failover occurs, up to N (e.g., 30) minutes of recent credential changes may need to be reconciled.

The controller operates as part of a backend automation system that handles disaster recovery functionality without direct customer visibility. While customers can enable disaster recovery during provisioning, the controller manages the complex synchronization of security credentials automatically behind the scenes. This ensures business automations can continue operating seamlessly even when failing over to a backup region.

The data flow arrows 118 represent the directional flow of credential data and control information throughout the cloud-based vault replication system. These arrows indicate the movement of different types of credentials between storage systems and across regions during the synchronization process. For example, when a customer creates a new OAuth connection, data flow arrows 118 show how the initial credentials flow from the input interface to the secrets manager, which then directs different credential components to appropriate storage systems—static credentials to the secure vault and ephemeral tokens to the distributed cache.

The arrows also illustrate the bi-directional synchronization paths between primary and secondary regions. The system implements polling-based replication that checks for changes every N (e.g., 30) minutes. The data flow arrows 118 demonstrate how credential updates flow from a tenant's primary region to their secondary region through various components, like the change log, poller, and cross-region replication mechanisms. For instance, when a credential receives an update in the primary region, the data flow arrows 118 show the path from the change detection system to the replication mechanism that synchronizes the data to the secondary region.

The data flow arrows 118 further depict the transformation of credentials during the replication process. The arrows show how credential data moves through the customer secrets manager component, which handles necessary data transformations while maintaining consistent handling across regions. This visualization includes flows for both simple credential updates as well as complex scenarios involving multiple related credentials acquired asynchronously, such as OAuth flows with initial consent tokens followed by access and refresh tokens.

The arrows also represent the logical separation of different credential types and storage paths. For example, the arrows show how static credentials flow to the hardware secure vault while ephemeral tokens are directed to distributed caches optimized for frequent updates. This visualization helps explain how the system optimizes credential storage based on update frequency and security requirements while maintaining comprehensive synchronization across regions.

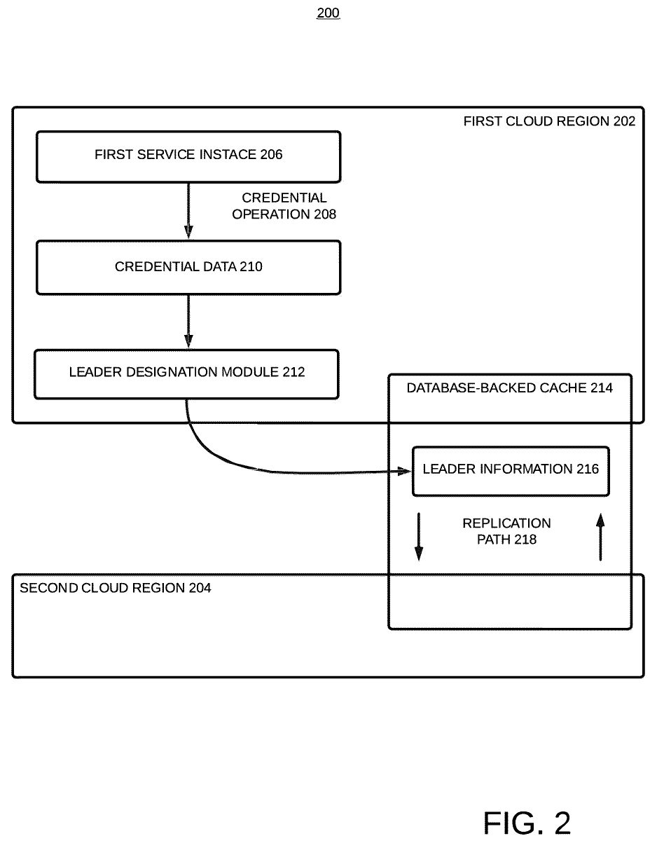

FIG. 2 illustrates a system 200 for designating a leader service instance and storing leader information in a replicated database-backed cache across cloud regions according to one or more embodiments. The system 200 represents an extension to the system 100 of FIG. 1. Unless the context clearly indicates otherwise, the system 200 can be implemented in conjunction with or independently of the other extensions of the system 100 of FIG. 1 disclosed herein.

The system 200 designates service instances as leaders when they perform operations on credential data and maintains this leadership information across cloud regions. When a first service instance performs an operation on credential data, the system 200 designates the service instance as a leader service instance. The system 200 then stores information about this leader designation in a database-backed cache. This cache undergoes replication between the first cloud region and the second cloud region to maintain consistency of leadership information. This leadership designation and replication work in conjunction with the credential data synchronization process, where credential data associated with a tenant identifier is received, stored, and replicated between cloud regions. The leader information helps coordinate operations across regions while enabling failover capabilities and maintaining operational continuity. By storing leader information in a replicated database-backed cache, the system 200 ensures that both regions have consistent knowledge of which service instance has authority for credential data operations.

The first cloud region 202 is a primary cloud computing environment that manages credential data and hosts tenant workloads. It serves as the active instance for credential creation and updates with data being replicated to a secondary region. The region, which could be exemplified as a Sydney data center supporting multiple tenants per cell, uses hardware secure vaults for static credentials and distributed caches for ephemeral credentials. It operates on a leader-based architecture with a designated Leader_SI and handles various credential operations. The region supports bi-directional synchronization, allowing it to function as either primary or secondary region, and ensures credential updates propagate to paired regions within N (e.g., 30) minutes while maintaining consistency through primary region-only updates.

The second cloud region 204 is a geographically separate cloud environment that serves as a disaster recovery backup for credential data. It mirrors the storage systems of the first cloud region, including secure vaults and distributed caches, and maintains synchronized credential data. The region operates in a leader-based architecture with bi-directional synchronization capabilities, allowing it to take over operations seamlessly during failover events to ensure continuous business operations.

The first service instance 206 is a cloud computing service instance that leads credential data operations. It becomes the leader when it is the first to perform create, read, update, or delete (CRUD) operations on credentials. The instance's leadership status is stored in a distributed, database-backed cache and replicated across regions using a real-time data replication mechanism. Other service instances check this leadership information before performing credential operations to maintain consistency. This leader-based architecture helps prevent conflicts and supports disaster recovery while ensuring coordinated credential management across regions, particularly for complex scenarios like OAuth flows.

The credential operation 208 is a system for managing service instance leadership in multi-region cloud environments when handling credential data. It works by designating the first service instance performing credential actions as the Leader Service Instance (Leader_SI) and storing this information in a distributed, database-backed cache across regions. The system uses a managed, real-time data replication service for regional replication while preventing circular replication issues. When credential operations occur after failover events, the system uses cached Leader_SI information to maintain consistency in secret management. This mechanism ensures proper coordination of credential operations across regions and supports seamless failover capabilities while maintaining operational continuity.

The credential data 210 is a collection of security materials used for authentication and access in cloud service instances. It includes static credentials, certificates, encryption keys, and ephemeral tokens. The data is initially received in a first cloud region and requires proper management for business continuity.

The system uses different storage methods based on credential types—sensitive static credentials are stored in secure vaults, while ephemeral tokens are kept in distributed caches. The architecture follows a leader-based approach, where the first service instance performing a CRUD operation becomes the leader with leadership information tracked and replicated across regions.

This credential management system is useful for disaster recovery, ensuring security materials are synchronized between regions to maintain workflow continuity during failover events. The system adapts the credential data storage according to each region's requirements while maintaining logical relationships between different credential types.

The leader designation module 212 is a component that manages leadership roles in a multi-region cloud environment. It automatically designates the first service instance performing credential operations as the Leader_SI. The module uses a distributed, database-backed cache to store leadership information, which is replicated between regions using a real-time data replication mechanism. When a service instance performs operations, the module records its leadership status and replicates this information across regions. The system maintains consistency in secret management by tracking which service instance has authority over credential operations, particularly during failover events. Working with the broader credential system, it ensures leadership consistency across regions while supporting an N (e.g., 30)-minute replication SLA for eventual consistency.

A distributed, database-backed caching system stores leadership information for service instances handling credential operations. The cache is SI-striped, organizing entries by Service Instance identifiers, with service instances becoming leaders when performing credential operations. Leadership information replicates between regions using a real-time database replication mechanism. The system uses this distributed cache instead of message brokers to track secret changes efficiently. The cache enables CRUD operations after failover by providing Leader_SI information, ensuring consistency across regions. Its hybrid nature combines database durability with cache performance benefits, making it effective for managing service instance leadership in cloud environments.

The leader information 216 is a system for managing leadership designation in a cloud-based secret management system. It identifies which service instance leads credential operations through a distributed, database-backed, service instance-striped cache replicated across cloud regions. The first service instance performing a CRUD operation becomes the Leader_SI, with this designation stored against a constant key in the cache. The information is replicated between regions using a real-time data replication service. This system ensures consistent secret management across service instances during failover events by using the cached Leader_SI information to construct secret names. The distributed, database-backed cache approach provides a simpler solution compared to alternatives, such as message brokers, while maintaining consistency through regional replication.

The replication path 218 is a system for synchronizing credential data between cloud regions in a multi-tenant environment. It uses a leader-based architecture, where the first service instance handling a secret operation becomes the Leader_SI, with this information stored in a distributed, database-backed cache. The path enables bi-directional replication while maintaining data consistency and tenant isolation. It uses a real-time database replication service for database replication and operates on an N (e.g., 30)-minute polling cycle for change detection. The system enforces primary/secondary relationships for each tenant to prevent conflicts though the overall path supports two-way replication to accommodate different tenant configurations.

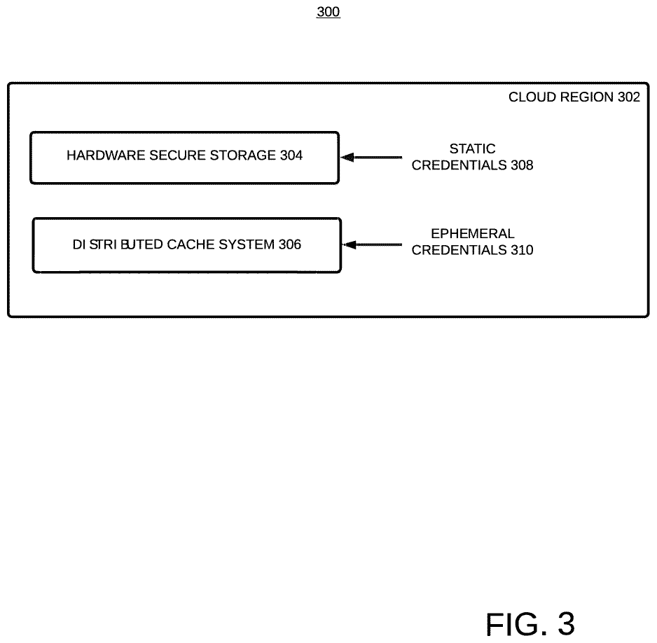

FIG. 3 illustrates a system 300 for storing static credentials in hardware secure storage and ephemeral credentials in a distributed cache within a cloud region according to one or more embodiments. The system 300 represents an extension to the system 100 of FIG. 1. Unless the context clearly indicates otherwise, the system 300 can be implemented in conjunction with or independently of the other extensions of the system 100 of FIG. 1 disclosed herein.

The system 300 stores different types of credential data in storage systems based on the characteristics and usage patterns of the credentials. The system 300 stores static credentials, which are long-lived and require high security, in a hardware secure storage system. Such storage provides enhanced protection for sensitive credential information that changes infrequently. The system 300 also stores ephemeral credentials, which are temporary and frequently updated, in a distributed cache that has been optimized to handle rapid changes. This storage approach allows the system to efficiently manage both persistent and temporary credentials while maintaining appropriate security levels for each type. The distributed cache enables quick access and updates to short-lived credentials, while the hardware secure storage provides robust protection for long-term sensitive data. The storage strategy supports the overall credential synchronization and failover capabilities between cloud regions while ensuring proper handling of different credential types.

The cloud region 302 represents a geographical deployment zone in cloud computing that handles credential data storage. The region employs a hybrid storage approach, hardware secure storage for static credentials (like usernames/passwords) and distributed cache systems for ephemeral credentials (like OAuth tokens). The region can serve multiple tenants per cell using a multi-tenant architecture with a single shared vault instance. A secrets manager component intelligently segregates credentials to appropriate storage systems, optimizing both security and performance while enabling disaster recovery through replication to secondary regions.

The hardware secure storage module 304 serves as a component designed to securely store static credentials, like usernames, passwords, and certificates. The storage module functions as a vault optimized for sensitive but infrequently updated credentials. In a multi-tenant architecture, the storage module serves multiple tenants per region using unique canonical identifiers combining tenant ID, instance ID, and connection details. The module works with the customer secrets manager for data operations and implements custom replication logic for cross-region synchronization of credentials while maintaining security, particularly important for disaster recovery scenarios.

The distributed cache system 306 represents a storage component for managing ephemeral credentials in cloud-based credential management. The system 306 is optimized for frequent read/write operations of temporary authentication tokens and session keys. The system uses a hybrid storage approach, storing short-lived access tokens in the distributed cache while keeping permanent credentials in hardware secure storage. The cache receives backing from a database and uses a distributed, in-memory, key-value store for tracking credential updates. The cache works alongside hardware secure storage to provide comprehensive credential management—the cache handles frequently changing ephemeral credentials while hardware storage manages static, long-lived credentials. This system enables efficient credential synchronization across cloud regions for disaster recovery.

The static credentials 308 are permanent authentication materials, like usernames, passwords, and certificates, stored in hardware secure storage for enhanced protection. Unlike ephemeral credentials, these static credentials require maximum security, for the static credentials represent root access credentials configured by customers. The system optimizes the handling of static credentials for security over quick access, using vault APIs for secure cross-region replication while maintaining encryption. The hardware secure storage provides features, like encryption at rest, secure key management, and hardware-based protection, for these sensitive, long-lived credentials.

The ephemeral credentials 310 are temporary security materials that require frequent updates and are stored in a distributed cache system. These include OAuth access tokens and other automatically generated tokens with limited validity periods. The system processes these credentials differently from static ones due to the transient nature, using database replication technology for cross-region synchronization. The distributed cache storage is designed to handle high-frequency updates while maintaining relationships between different types of credentials generated during authentication flows. This approach prevents overwhelming hardware secure storage systems and allows for credential reconstruction after failover events.

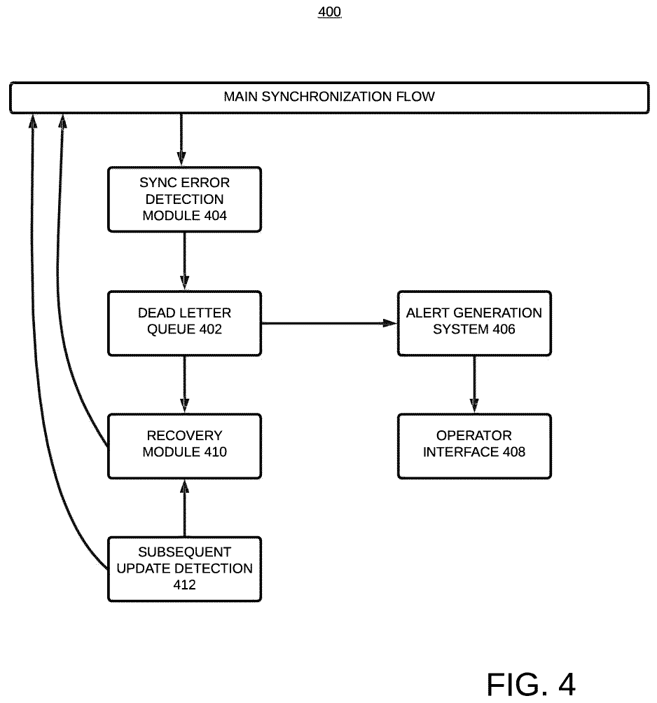

FIG. 4 illustrates a system 400 for handling credential synchronization errors using a dead letter queue and automated recovery based on subsequent successful updates according to one or more embodiments. The system 400 represent an extension to the system 100 of FIG. 1. Unless the context clearly indicates otherwise, the system 400 can be implemented in conjunction with or independently of the other extensions of the system 100 of FIG. 1 disclosed herein.

The system 400 enhances error handling and recovery during credential data synchronization between cloud regions. When detecting an error during the synchronization process of credential data from the first cloud region to the second cloud region, the system implements a robust error management protocol. The system stores the problematic credential data in a dead letter queue, which serves as a temporary holding area for failed synchronization attempts. Upon storing the credential data in the dead letter queue, the system automatically generates an alert to notify operators of the synchronization failure, enabling timely human intervention to address the underlying issues. The system monitors subsequent synchronization attempts and, upon detecting a successful synchronization of a later update to the credential data, initiates a recovery process. During recovery, the system retrieves the previously failed credential data from the dead letter queue, effectively maintaining data consistency and ensuring no credential updates are permanently lost. This error handling mechanism operates within the broader context of the cross-region credential synchronization process, which includes receiving, storing, and transforming credential data while enabling failover capabilities between cloud regions.

The dead letter queue 402 serves as an error handling system for credential data synchronization failures between cloud regions. The queue stores failed credential data and works with an alert system to notify operators of synchronization errors. The queue features both automatic and manual recovery mechanisms—when new updates successfully sync, the system can automatically recover previous failed attempts. The queue ensures no credential updates are lost due to temporary failures and maintains consistency for disaster recovery scenarios. The queue provides error tracking and operator visibility while supporting the overall credential synchronization process.

The synchronization error detection module 404 serves as a component in vault replication that handles error detection and recovery during credential synchronization between cloud regions. The module monitors synchronization and uses a Dead Letter Queue (DLQ) approach for error management, placing failed credential data into the DLQ and alerting operators. The module features automatic recovery capabilities when new updates to previously failed credentials succeed. Operating within a broader system that synchronizes credentials every N (e.g., 30) minutes, the module employs a double-check mechanism to verify consistency during transfers. If changes occur during transfer, credentials return to the change secrets cache for re-replication. When synchronization fails, like during network issues, the module queues affected credentials in the DLQ until successful resynchronization occurs.

The alert generation system 406 handles error notifications and recovery processes for failed credential synchronization between cloud regions. The system works with a DLQ to store problematic credentials and automatically notifies operators when synchronization errors occur. The system includes an automatic recovery mechanism that monitors for successful synchronization of previously failed credentials and can trigger automatic recovery from the DLQ when possible. This approach helps maintain operational continuity by providing visibility into issues through alerts while minimizing manual intervention through automated recovery processes.

The operator interface 408 serves as a system component managing credential synchronization errors through a DLQ mechanism. The interface allows human operators to monitor and resolve synchronization failures between regions following standard operating procedures. The interface receives alerts when credential data fails to synchronize, provides visibility into failed attempts, and supports both automatic and manual recovery processes. When automatic recovery is not possible, operators can manually intervene to resolve issues. The interface plays a useful role in maintaining credential availability across regions in a multi-tenant environment and ensuring business continuity during failover scenarios.

The recovery module 410 represents a component that handles errors and recovery in cloud-based credential replication systems. The module detects synchronization errors and stores problematic credential data in a DLQ. The module automatically attempts to recover failed entries when subsequent successful updates are detected for the same credentials. The Recovery Module 410 includes an alerting system that notifies operators when manual intervention is needed and supports customer notification for unresolvable failures. The module proves useful for maintaining reliable disaster recovery and credential replication across cloud regions by ensuring proper tracking, management, and resolution of synchronization issues.

The subsequent update detection component 412 serves as a mechanism in a cloud-based credential replication system that monitors and identifies successful credential synchronizations after previous failures. This mechanism works with the DLQ where failed synchronizations are stored. When a new successful update for a previously failed credential becomes detected, the component triggers an automatic recovery process, reducing the need for manual intervention. The component operates within an N (e.g., 30)-minute synchronization SLA and uses canonical cross-regional identifiers to match successful updates with failed attempts in the DLQ.

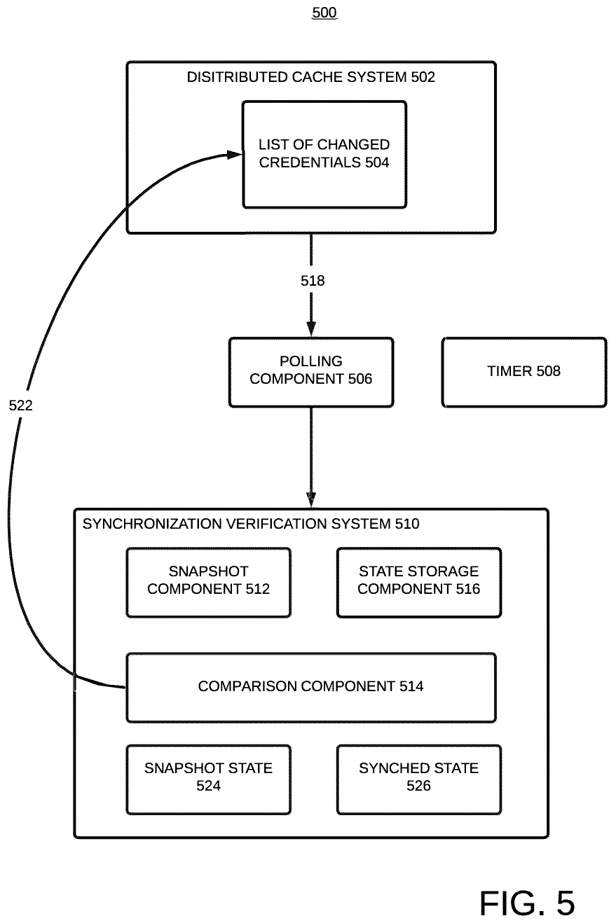

FIG. 5 illustrates a system 500 for detecting credential changes using distributed caching, polling at intervals, and verifying synchronization through state comparison according to one or more embodiments. The system 500 represents an extension to the system 100 of FIG. 1. Unless the context clearly indicates otherwise, the system 500 can be implemented in conjunction with or independently of the other extensions of the system 100 of FIG. 1 disclosed herein.

The system 500 implements a detailed change detection and verification process for credential data synchronization between cloud regions. The system maintains a list of changed credentials using a distributed cache system to track modifications to credential data. At predetermined intervals, the system polls this list to identify any credentials that require synchronization with the second cloud region.

After initiating the synchronization process for identified changes, the system performs a verification step to ensure data consistency. The system takes a snapshot of the current state of the credential data and compares this snapshot to the state of the synchronized credential data in the second cloud region. If the system detects a mismatch between these states, indicating that additional changes occurred during the synchronization process, the system returns the credential data to the list for another synchronization attempt. The verification mechanism ensures that changes are properly propagated between cloud regions while maintaining data integrity.

The change detection and verification process works in conjunction with the broader credential synchronization framework, where the system receives, stores, and replicates credential data between cloud regions based on tenant identifiers. The process helps maintain accurate credential synchronization, which proves useful for enabling successful failover operations while preserving operational continuity for the tenant.

The distributed cache system 502 serves as a component for managing credential changes in a cloud-based, multi-region environment. The system uses a distributed, in-memory, key-value store to track credential modifications and maintains a list of changes requiring synchronization across regions. The distributed cache system optimizes efficiency by consolidating multiple updates to the same credential into a single entry. The system operates on N (e.g., 30)-minute polling intervals and implements a double-check verification process to ensure consistency. The distributed cache system proves particularly effective for handling ephemeral credentials like OAuth tokens and features database backing and SI-striping for maintaining consistency across service instances while supporting disaster recovery capabilities.

The distributed cache system maintains a list of changed credentials in a distributed, in-memory, key-value store that serves as a change log. The distributed cache system efficiently stores unique entries per credential during each polling period even if multiple updates occur. The distributed cache system polls this list every N (e.g., 30) minutes and uses a verification mechanism to ensure consistency by comparing snapshots of credential states before and after synchronization. If changes occur during synchronization, the credential is re-added to the list for another attempt, ensuring accurate replication of the most recent credential state across regions.

The polling component 506 serves as a part of a credential synchronization system that checks for credential data changes across cloud regions every N (e.g., 30) minutes. The component leverages a distributed, in-memory, key-value store as a distributed cache to track changed secrets. This component implements a streamlined approach where multiple updates to the same secret within a polling period are consolidated into a single entry. The component features a double-check verification mechanism that compares snapshots of credential states to ensure data consistency. If discrepancies are found during synchronization, the credential is re-queued for another synchronization attempt to maintain data integrity across regions.

A polling mechanism represented by clock/timer symbol 508 checks for credential changes across cloud regions every N (e.g., 30) minutes. The polling mechanism proves useful for maintaining eventual consistency in the system by detecting and synchronizing credential updates between primary and secondary regions. The mechanism works with a double-check verification process that compares credential states to ensure accurate synchronization. The polling system employs a distributed, in-memory, key-value, store-based implementation to track changed secrets efficiently, where multiple updates to the same secret during a polling interval are consolidated into a single entry for streamlined synchronization.

The synchronization verification system 510 serves as a mechanism that ensures accurate credential data synchronization between cloud regions through a double-check verification process. The mechanism operates by taking snapshots of credential data before synchronization and comparing the snapshots with the final synchronized state in the secondary region. The system uses a distributed, in-memory, key-value store as a distributed cache to track credentials requiring synchronization. If any discrepancies are detected, the credential returns to the change list for re-synchronization. This process continues until the synchronized state matches the snapshot state. The system plays a useful role in maintaining data consistency and disaster recovery capabilities in multi-tenant cloud environments where credentials are frequently updated.

The snapshot component 512 serves as a verification mechanism for credential synchronization that ensures data consistency during cross-region replication. The component captures credential data at specific points in time before synchronization begins and uses this data as a reference for verification after synchronization completes. Working with a polling-based replication system that checks for changes, the snapshot component captures the current state when changes are detected in the distributed, in-memory, key-value, store-based change list. After synchronization, the component compares the original snapshot with the final state and returns any discrepancies to the change list for re-replication. This double-check mechanism helps maintain consistency in a multi-tenant environment supporting multiple tenants per cell, ensuring exact matches between regions and supporting eventual consistency for cross-region replication.

The comparison component 514 serves as a verification mechanism in a cloud-based credential replication system that ensures data consistency during synchronization between regions. The mechanism works by comparing credential data snapshots before and after replication. When mismatches are detected, the comparison component triggers a recovery process by returning credentials to the changed credentials list for re-synchronization. This component handles concurrent updates during the synchronization window and maintains eventual consistency across regions for disaster recovery purposes.

The state storage component 516 is a distributed cache system that tracks credential changes and verifies states during synchronization in a cloud-based, credential replication system. The component uses a distributed, in-memory, key-value store to track changed credentials, consolidating multiple updates into single entries for efficiency. The component implements a double-check mechanism using snapshots to verify consistency during synchronization. If changes occur during transfer, credentials return to the change list for re-synchronization. Working with a polling mechanism, the component maintains an optimized change log focusing on recent states rather than full history, supporting eventual consistency while enabling efficient storage and retrieval.

A component in a distributed cache system handles credential synchronization across regions. The list to polling component arrow 518 shows how changed credential information flows from a maintained list to a polling mechanism. The system leverages a distributed in-memory key-value store as a distributed cache and implements polling-based replication. When credentials are updated in the primary region, changes are recorded in a distributed in-memory key-value store and retrieved by the polling component during scheduled checks. Multiple updates to the same secret within a polling period are consolidated into a single entry for efficiency. The system delivers eventual consistency for cross-region replication, ensuring reliable credential propagation.

The polling component and synchronization verification system work together to manage credential synchronization across regions. The polling component checks for credential changes in a distributed, in-memory, key-value store cache. When changes are detected, the verification system takes a snapshot before synchronization and compares the snapshot to the final state to ensure consistency. If mismatches occur due to concurrent modifications, the credential returns to the change list for re-synchronization. The system proves useful for maintaining data consistency in a multi-tenant environment with multiple tenants per cell making credential updates that need cross-region synchronization.

A feedback loop mechanism (arrow 522) in a credential synchronization system ensures data consistency across cloud regions. The mechanism returns credential data to a change tracking list when synchronization verification fails, allowing for subsequent synchronization attempts. The system employs a distributed, in-memory, key-value, store-based cache to track changed secrets during polling periods. When changes occur during synchronization or states do not match, the feedback loop returns credentials to the change secrets cache for replication. The process continues until the replicated state matches the latest state, supporting the system's eventual consistency guarantee for cross-region replication.

Thesnapshot state 524 represents a verification component in credential synchronization that ensures data consistency during cross-region replication. The component compares two states, an initial snapshot of credential data and the final synchronized state in the target region. Operating within a polling-based replication system, the comparison component implements a double-check mechanism for data like OAuth tokens. When discrepancies are detected, the credential returns to the change secrets cache for re-replication. The component plays a useful role in the distributed, in-memory, key-value, store-based implementation for maintaining changed secrets lists and supporting eventual consistency for cross-region replication.

The synched state 526 represents as a verification component in credential synchronization that ensures data consistency across cloud regions by comparing snapshots of credential data states. When credentials are updated in the primary region, the component verifies that the replicated state in the secondary region matches the original snapshot. If discrepancies are found, the system triggers another synchronization attempt. Operating as part of a polling-based replication mechanism, the synched state 526 works with a distributed, in-memory, key-value, store-based cache to maintain changed secrets. The component is useful in multi-tenant environments to prevent inconsistencies from concurrent updates and maintain eventual consistency for cross-region replication.

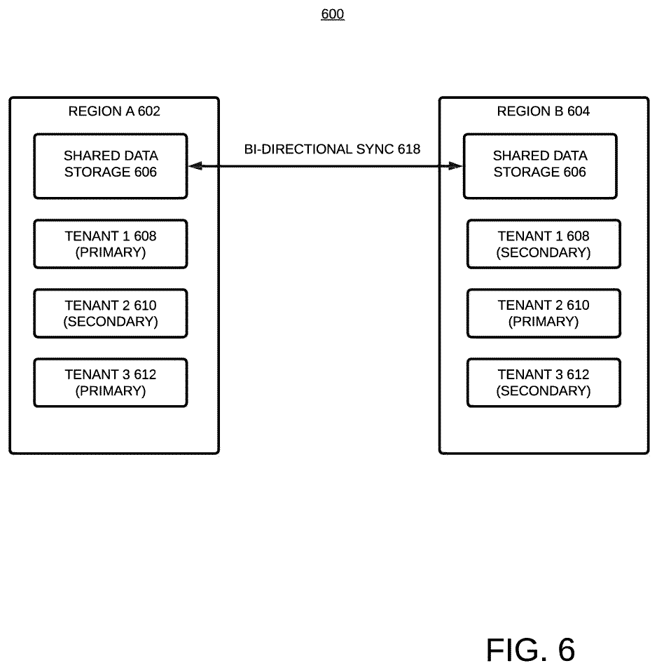

FIG. 6 illustrates a system 600 for bi-directional synchronization between cloud regions using shared data storage instances serving multiple tenants with designated primary and secondary regions according to one or more embodiments. The system 600 represents an extension to the system 100 of FIG. 1. Unless the context clearly indicates otherwise, the system 600 can be implemented in conjunction with or independently of the other extensions of the system 100 of FIG. 1 disclosed herein.

The system 600 operates in a multi-tenant cloud environment where the first cloud region includes a shared data storage instance that serves multiple tenants. Each tenant in the system receives assignment of both a primary region and a secondary region for operations. To maintain data consistency and prevent conflicts, the system enforces a restriction that allows credential updates to occur in each tenant's designated primary region. The system enables bi-directional synchronization between the first and second cloud regions by leveraging the fact that different tenants can have different primary regions. For example, when the first cloud region serves as the primary region for a first tenant and the second cloud region serves as the primary region for a second tenant, credential updates for the first tenant flow from the first cloud region to the second cloud region, while credential updates for the second tenant flow in the opposite direction. This bi-directional synchronization occurs while maintaining the credential data in the shared data storage instance and following the transformation and storage processes defined for credential synchronization between regions. The system continues to enable failover capabilities while enforcing these tenant-specific primary region restrictions and maintaining the bi-directional synchronization paths.

The cloud region A 602 is a cloud computing environment that uses a shared, multi-tenant architecture for credential data storage and management. The environment can serve as either a primary or secondary region for different tenants and includes shared storage systems supporting multiple tenants per cell. The region implements a shared vault instance for multiple tenants rather than separate instances per tenant, maintaining data isolation while sharing infrastructure. The region stores static credentials in a hardware secure vault and ephemeral tokens in distributed caches. As a primary region, the environment handles credential updates and syncs with secondary regions, while as a secondary region the environment receives updates from other primary regions. This architecture enables efficient resource usage and disaster recovery while maintaining security and tenant isolation.

The cloud region B 604 represents a failover destination in a multi-tenant cloud environment that enables bi-directional credential synchronization. The region functions as both a primary and secondary region for different tenants with corresponding storage systems that mirror the first cloud region's infrastructure. The region maintains secure vaults and distributed caches for transformed credential data, implements strict access controls, and supports multiple tenants per cell while keeping data isolated. The region uses a polling-based replication mechanism checking to maintain synchronized credentials for disaster recovery and business continuity.

The shared data storage instance 606 is a multi-tenant cloud storage system that centralizes credential data for multiple customers within a cloud region. The system can serve up multiple tenants per cell while maintaining logical data isolation between tenants. The system uses a single shared vault instance instead of separate instances for each tenant. The system supports bi-directional synchronization between regions with tenants able to designate different primary regions though credential updates can occur in a tenant's primary region to maintain consistency. The system uses canonical cross-regional identifiers combining tenant ID, instance ID, and connection details to maintain proper credential referencing across regions.

The multiple tenants 608 is a cloud-based system that allows different customers to share data storage infrastructure while keeping their credential data separate. The system can support multiple tenants per cell in a region with each tenant having primary and secondary instances in different regions for failover. Instead of separate vaults, tenants share a single vault instance in a multi-tenant cell. The system enables bi-directional synchronization between regions while maintaining data consistency through strict primary/secondary relationships for each tenant. The isolation of tenants is achieved through non-colliding synchronization paths and segregated data storage, ensuring security while maximizing resource efficiency.

The multiple tenants 610 represents a cloud system architecture where different customers share data storage infrastructure while maintaining logical separation. Each tenant operates with a primary region for credential updates and a secondary region for failover. The system accommodates multiple tenants per cell, using a shared vault instance in each region. Tenants can have different primary/secondary region configurations, enabling efficient bi-directional synchronization of credentials while maintaining isolation. Updates are restricted to primary regions and replicated to secondary regions, optimizing resource usage while ensuring disaster recovery capabilities.

The multiple tenants 612 is where a single shared storage instance serves multiple tenants per cell. Each tenant has a primary and secondary region for operations and failover. Credential updates can occur in a tenant's primary region. The system implements a shared vault deployment where one vault instance serves tenants while maintaining data isolation. The architecture enables efficient bi-directional synchronization between regions through non-colliding synchronization paths, for each tenant's updates are restricted to the tenant's primary region. This design supports disaster recovery and maintains data consistency while optimizing resource utilization.

The primary/secondary designation indicators indicate which region serves as primary or secondary for each tenant, controlling credential updates and synchronization. The system supports multiple tenants per cell with each tenant having primary and secondary instances in different regions. For example, if Tenant A has Region 1 as primary and Tenant B has Region 2 as primary, credentials flow from Region 1 to Region 2 for Tenant A, and vice versa for Tenant B. This approach prevents credential conflicts during two-way replication and maintains data consistency in the multi-tenant architecture.

The system enables different tenants to have different primary regions with credential updates flowing from primary to secondary regions. While individual tenant credentials flow one-way, the overall system supports two-way replication between regions. The synchronization operates for cross-region replication and handles various credential types across storage systems, ensuring seamless operation during failovers. The system leverages shared vault instances in each region for efficient multi-tenant service.

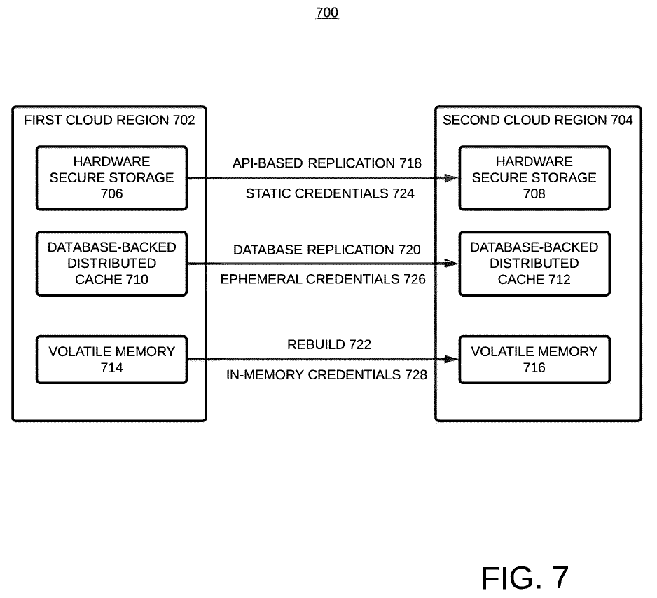

FIG. 7 illustrates a system 700 for storing and synchronizing static, ephemeral, and in-memory credentials across multiple cloud regions using distinct storage systems and replication mechanisms according to one or more embodiments. The system 700 represents an extension to the system 100 of FIG. 1. Unless the context clearly indicates otherwise, the system 700 can be implemented in conjunction with or independently of the other extensions of the system 100 of FIG. 1 disclosed herein.

The system 700 stores different types of credential data in specific storage systems based on their characteristics and synchronizes them across cloud regions using appropriate mechanisms. The system stores static credentials, which are long-term and highly sensitive, in a hardware secure storage for maximum protection. The system places ephemeral credentials, which have shorter lifespans, in a database-backed distributed cache for efficient access and management. In-memory credentials, which are temporary and frequently accessed, reside in volatile memory for rapid retrieval.

When synchronizing credential data between cloud regions, the system 700 employs distinct replication strategies for each credential type. The system replicates static credentials using hardware secure storage APIs, ensuring the secure transfer of sensitive data while maintaining hardware-level protection. The system replicates ephemeral credentials through database replication technology, preserving their temporal nature and consistency across regions. For in-memory credentials, rather than direct replication, the system rebuilds them in the second cloud region using the already replicated static and ephemeral credentials as a foundation. This comprehensive approach ensures proper handling and protection of each credential type while maintaining their availability and integrity across cloud regions.

A first cloud region 702 serves as the main deployment zone for credential data storage and management. This region implements a multi-tiered storage system for different types of credentials: static credentials are stored in hardware secure storage; ephemeral OAuth tokens are stored in database-backed distributed cache; and some credentials are stored in volatile memory. The region operates as the primary operational environment for tenants that can access one region at a time. The region handles initial credential processing and coordinates replication to secondary regions. The region also maintains change logs and uses polling mechanisms to identify and synchronize credential updates across regions for disaster recovery purposes.

A second cloud region 704 serves as a geographically distinct failover destination for disaster recovery. This region maintains synchronized copies of credential data and can take over operations during primary region outages. The region includes mirrored storage systems for different types of credentials: hardware secure storage for static credentials, database-backed distributed cache for ephemeral credentials, and volatile memory for in-memory credentials. The synchronization process uses different replication mechanisms based on credential type, including hardware secure storage APIs and database replication technology. The secondary region maintains eventual consistency, ensuring seamless failover capability and business continuity.

The hardware secure storage 706 serves as a storage system for protecting static credentials in cloud computing. The storage functions as a secure vault for sensitive, long-lived credentials, such as usernames, passwords, and certificates. While the storage system stores static credentials, other systems handle more dynamic authentication materials like OAuth tokens. The system uses APIs for cross-region replication since the storage lacks native multi-master replication. The storage operates in a multi-tenant architecture, where one vault instance serves multiple tenants within each region while maintaining isolation between different tenants'credentials.

The hardware secure storage 708 serves as a storage system for protecting static credentials in cloud computing. The storage functions as a vault for sensitive, long-lived credentials, such as usernames, passwords, and certificates. While the storage system maintains static credentials, like username/password pairs, other components handle ephemeral tokens like OAuth. The system uses APIs for secure credential replication between regions, maintaining security during cross-region synchronization. The hardware secure storage exists as part of a multi-tiered storage strategy, where different credentials reside in different systems based on security needs and update frequency with hardware secure storage providing the highest level of protection for sensitive static credentials.

The database-backed distributed cache 710 represents a storage system for managing ephemeral credentials in cloud-based, multi-tenant environments. The system combines distributed caching performance with database persistence. The cache specifically stores temporary credentials, such as OAuth tokens and session tokens, that require frequent updates. The system uses database replication technology for cross-region synchronization and works alongside other storage systems to provide comprehensive credential management. The system optimizes storage by separating ephemeral tokens into distributed caches while keeping static credentials in hardware secure modules.

The database-backed distributed cache 712 represents a storage system for managing ephemeral credentials in cloud-based credential management. The system combines distributed caching with database persistence to store temporary authentication materials, like OAuth tokens, that require frequent updates. The system uses database replication technology to synchronize credentials across regions, making the approach more efficient than hardware secure storage APIs for frequently changing credentials. The system maintains consistency through a hybrid approach, coordinating with other credential stores while enabling disaster recovery. The cache works alongside hardware secure storage and volatile memory, providing an optimal solution for credentials needing both persistence and frequent updates.

The volatile memory 714 is a temporary storage component in cloud infrastructure used for storing in-memory credentials that require quick access but not persistence across system restarts. The component functions as part of a hybrid storage approach where credentials are stored in different systems based on their characteristics. During OAuth flows, the volatile memory 714 stores per-request tokens and signatures computed dynamically. Unlike other credential types, these credentials are not directly replicated between regions. During failover, the secondary region rebuilds in-memory credentials using replicated static and ephemeral credentials. The system uses a reconstruction approach rather than direct synchronization between regions. The volatile memory 714 optimizes access to frequently needed or computed-on-demand credentials, such as request signatures and temporary session tokens.

The volatile memory 716 serves as a temporary storage component in cloud infrastructure used for storing in-memory credentials that need quick access but do not need to persist after system restarts. The component functions as part of a hybrid storage system where credentials are stored in different locations based on their characteristics. During OAuth flows, the volatile memory stores temporary tokens and signatures. Unlike other credential types, these temporary credentials are not directly replicated between regions. During failover, the system rebuilds the in-memory credentials in the secondary region using replicated static and ephemeral credentials. This reconstruction approach replaces direct synchronization across regions using secure hardware storage and database-backed cache as sources. This design supports fast access for frequently accessed and regenerated credentials while working alongside more permanent storage solutions.

The API-based replication 718 represents a system for securely replicating static credentials between hardware secure storage systems across cloud regions using their native APIs. The system specifically handles highly sensitive credentials, like usernames, passwords, and certificates, that rarely change. The process involves reading credentials from the source hardware secure storage, transforming them as needed, and writing them to the destination storage using respective APIs. This approach functions as part of a hybrid synchronization strategy, where different types of credentials are handled through appropriate methods—database replication for ephemeral credentials and API-based replication for static credentials requiring hardware-level security protection. The system ensures sensitive data remains protected by hardware security modules throughout the replication process.

The database replication 720 represents a technology for replicating ephemeral credentials across cloud regions in a database-backed distributed cache. The technology specifically handles synchronization of frequently changing credentials, like OAuth tokens and temporary access keys, as part of a hybrid synchronization approach. The system leverages database replication to maintain consistency of ephemeral credentials, enabling seamless failover between regions while preventing overload of secure hardware storage with short-lived credential writes.

The rebuild 722 represents a process for reconstructing in-memory credentials in secondary cloud regions using previously replicated static and ephemeral credentials. Instead of directly replicating volatile memory data, the process rebuilds credentials by deriving them from underlying replicated data. The reconstruction occurs after failover events and remains useful for handling dynamic tokens and signatures. The approach leverages static credentials from secure hardware storage and ephemeral credentials from database caches that are already replicated through other mechanisms. This methodology proves more practical than directly replicating in-memory credentials and is useful for managing OAuth flows and per-request tokens.

The static credentials 724 are permanent authentication materials, such as usernames, passwords, and certificates, that are stored in a hardware secure storage module for enhanced security. Unlike ephemeral credentials, these permanent credentials remain unchanged for long periods and require special handling through vault APIs for cross-region synchronization. The system stores these authentication materials in secure hardware specifically because the credentials change infrequently, optimizing storage while maintaining maximum security. This approach differs from ephemeral tokens or in-memory credentials, which have different storage requirements based on update frequency and security needs.

The ephemeral credentials 726 are temporary security credentials, like OAuth tokens, that require frequent updates. These credentials are stored in a database-backed distributed cache system for optimal performance and persistence. The system synchronizes these credentials between regions using database replication technology, maintaining consistency. During failover events, the replicated credentials ensure continuous authentication and token refresh processes in the secondary region. The database-backed cache system delivers both quick access and reliability for managing these temporary security materials.

The in-memory credentials 728 are temporary credentials stored in volatile memory during system operation, typically generated dynamically for immediate request processing. Unlike static and ephemeral credentials that are directly replicated between regions, in-memory credentials are rebuilt in secondary regions using replicated credential material. This approach proves more efficient since these credentials are temporary. During failover scenarios, the secondary region can quickly regenerate in-memory credentials using synchronized static and ephemeral credentials, ensuring business continuity and availability of credential types for request processing.

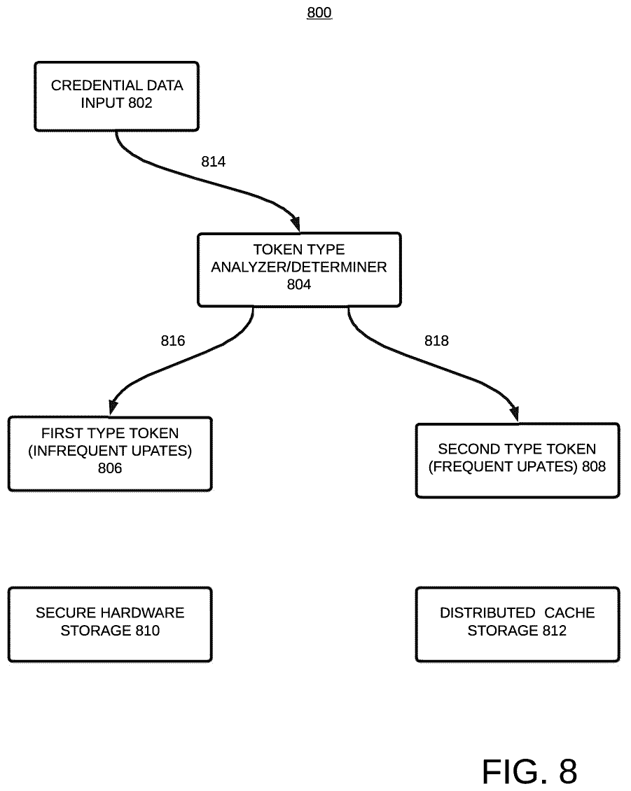

FIG. 8 illustrates a system 800 for storing different types of authentication tokens in secure hardware or distributed cache storage based on update frequency characteristics according to one or more embodiments. The system 800 represents an extension to the system 100 of FIG. 1. Unless the context clearly indicates otherwise, the system 800 can be implemented in conjunction with or independently of the other extensions of the system 100 of FIG. 1 disclosed herein.

The system 800 stores credential data by analyzing and categorizing different types of authentication tokens based on their characteristics and update frequencies. The system 800 first determines two distinct types of authentication tokens from the received credential data. The first type of authentication token has characteristics indicating infrequent updates, while the second type has characteristics indicating frequent updates. Based on these characteristics, the system 800 optimizes storage locations for each token type. The system stores the first type of authentication token, which requires less frequent updates, in secure hardware storage to maintain high security while minimizing the performance impact of infrequent access. For the second type of authentication token that requires frequent updates, the system 800 stores these tokens in a distributed cache to enable quick access and efficient updates. This storage strategy ensures that the credential data synchronization between cloud regions, as described in the parent claim, can be performed efficiently while maintaining appropriate security levels for different types of authentication tokens.

The credential data input source 802 serves as an origin point for managing different types of authentication credentials and tokens. The source handles both static credentials (like usernames/passwords) and dynamic credentials (like OAuth tokens), processing them based on their update frequency characteristics. When customers create connections in an integration Platform as a Service (iPaaS), this input source receives and manages both initial credentials and derived tokens. The input source works with the secrets manager to appropriately store credentials across different systems—infrequently updated credentials go to secure hardware storage, while frequently updated ones are stored in distributed cache. This approach ensures optimal storage and management of different credential types while maintaining their relationships.

The token type analyzer/determiner 804 analyzes and classifies authentication tokens based on their characteristics and update patterns. The analyzer/determiner distinguishes between different types of tokens, like long-lived refresh tokens and short-lived access tokens, by examining various factors, such as lifetime, update frequency, and security requirements. The system optimizes credential storage by directing static credentials to encrypted hardware secure modules and ephemeral tokens to distributed caches. The analyzer/determiner can handle complex scenarios with multiple token types acquired asynchronously, working with the secrets manager to ensure proper storage segregation while maintaining relationships between different credentials.

The first type authentication token 806 represents static credentials, such as usernames, passwords, and certificates, that rarely need updates. These tokens are stored in secure hardware storage (vault) due to the static nature and security requirements. Unlike other tokens that require frequent updates, these tokens form the foundation for secure connections. When replicating across regions, the system uses custom replication logic through vault APIs since native multi-master replication is not available, ensuring proper synchronization while maintaining security across primary and secondary regions.

The second type authentication token 808 represents dynamic credentials, like OAuth access tokens, that require frequent updates. Unlike the first type stored in secure hardware, these ephemeral tokens are stored in a distributed cache system to handle frequent changes efficiently. The cache system relies on database backing and can use replication technologies, like change data capture (CDC), for cross-region synchronization. This storage approach optimizes system performance while maintaining security in cloud-based, multi-tenant environments.

A secure hardware storage system 810 is designed for storing sensitive authentication tokens that require high security but infrequent updates. The storage system specifically stores static credentials, like usernames, passwords, and long-lived certificates. The storage system functions as a hardware secure vault and is part of a cloud-based credential management system. The secrets manager component directs static credentials to this storage while routing frequently changing credentials elsewhere. The storage system is optimized for security rather than write throughput and is part of a hybrid storage approach that helps maintain credential replication across cloud regions for disaster recovery.

The distributed cache storage 812 is a high-performance storage system designed for managing frequently updated authentication tokens in cloud-based credential management. The system forms part of a hybrid storage strategy where credentials are stored in different locations based on update frequency and security needs. While dynamic credentials, like OAuth tokens, are stored in this distributed cache, static credentials, like usernames and passwords, are kept in secure hardware storage. The system is implemented as a database-backed, service-instance-striped cache with replication capabilities using technologies like CDC. This architecture ensures efficient handling of ephemeral tokens while maintaining system performance and scalability across regions.

A credential data flow system is where incoming authentication tokens (flow 814) undergo analysis and categorization by the token type analyzer 804. The analyzer examines credentials to determine if the credentials are static (infrequently updated) or dynamic (frequently updated). This analysis proves useful for the system's hybrid storage approach, which optimizes credential storage based on update frequency and security requirements. Static credentials move to secure hardware storage, while dynamic tokens, like OAuth, reside in a distributed cache. This segregation ensures efficient storage while maintaining appropriate security levels for different types of credentials.

A system's credential management process is specifically focusing on the directional flow from analyzer to secure hardware storage. The analyzer evaluates credentials based on update frequency and determines appropriate storage locations. Static credentials, like usernames and passwords, that rarely change are directed to secure hardware storage, while frequently updated credentials, like OAuth tokens, are stored elsewhere. The optimization helps balance security requirements with efficient resource usage in a multi-tenant architecture where multiple users share a single vault instance within each region.

The analyzer component examines authentication tokens and routes those requiring frequent updates to a distributed cache storage system. This optimization strategy ensures that ephemeral tokens (like OAuth access tokens) with limited validity periods are stored in distributed caches rather than secure storage systems. The system implements a hybrid storage approach, directing different types of credentials to appropriate storage systems based on update patterns and security requirements. The distributed cache features specific design elements to handle high-frequency updates while maintaining rapid access performance.

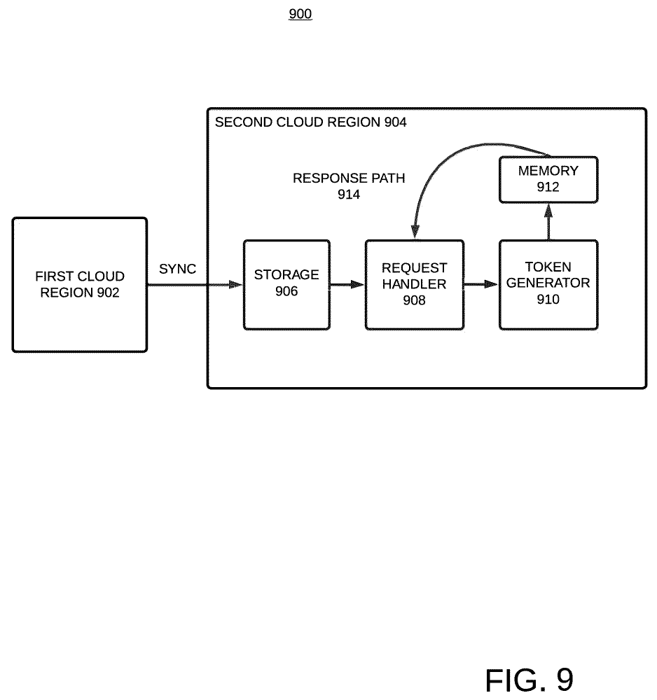

FIG. 9 illustrates a system 900 for synchronizing credential data between cloud regions and generating in-memory tokens from persistent credentials after failover operations according to one or more embodiments. The system 900 represents an extension to the system 100 of FIG. 1. Unless the context clearly indicates otherwise, the system 900 can be implemented in conjunction with or independently of the other extensions of the system 100 of FIG. 1 disclosed herein.

The system 900 synchronizes credential data between cloud regions by storing persistent credential material in a second cloud region after detecting changes in a first cloud region. After storing the persistent credential material and when failover occurs to the second cloud region, the system 900 receives requests that require tokens for authentication or authorization purposes. In response to such requests, the system 900 generates new, in-memory tokens using the previously stored persistent credential material. The system 900 then provides these generated, in-memory tokens to service the incoming requests. This approach allows for dynamic token generation in the failover region rather than attempting to synchronize short-lived tokens between regions. By storing the persistent credential material and generating tokens on-demand, the system 900 maintains security while ensuring service continuity during failover operations. This token generation process occurs within the broader context of credential synchronization between cloud regions, where credential data is transformed according to the requirements of the second cloud region before being stored in the corresponding storage systems.

The first cloud region 902 is a primary geographical deployment zone in a cloud computing infrastructure for managing credential data. This region includes multiple storage systems, including hardware secure vaults for static credentials and distributed caches for ephemeral tokens. The region operates as part of a disaster recovery pair with a second cloud region, synchronizing credential changes between regions. The region can use a shared vault instance and includes components like the customer secrets manager for credential data handling. The region serves as the active instance for assigned tenants until failover, maintaining authoritative credential data and handling credential-related operations.

A second cloud region 904 serves as a failover destination with disaster recovery capabilities. The region maintains synchronized copies of credential data using a hybrid storage approach—storing persistent credentials in a secure hardware vault while handling ephemeral tokens through in-memory generation. The region can support multiple tenants per cell and uses a shared vault instance across multiple tenants. The region participates in bi-directional synchronization, can serve as either primary or secondary region, and implements an eventual consistency model for cross-region replication. The region could be implemented as a geographically distributed data center such as Melbourne serving as a failover site for Sydney.

The storage 906 serves as a system for managing credential data storage across cloud regions. The component employs a hybrid storage approach, storing static credentials in a secure hardware vault while managing ephemeral tokens in distributed caches. For disaster recovery, persistent credentials are replicated to secondary regions, while ephemeral credentials are rebuilt on-demand using stored materials after failover. The component works with a customer secrets manager for data transformation and maintains referential integrity using canonical cross-regional identifiers, combining tenant ID, instance ID, and connection details.

The request handler 908 serves as an element in a cloud-based system that manages authentication tokens during failover events. The request handler component works with synchronized credential data to maintain operations in the secondary cloud region. The component dynamically generates in-memory tokens using replicated persistent credential materials rather than directly replicating ephemeral tokens between regions. The request handler component handles per-request tokens and signatures by computing them on-demand using stored credentials, like client secrets and encryption keys. This approach ensures security while enabling business continuity during failover scenarios, allowing customer workflows and integrations to continue seamlessly in the secondary region.

A token generator 910 dynamically generates authentication tokens during failover events in disaster recovery scenarios. Rather than replicating ephemeral tokens between regions, the token generator reconstructs them on-demand using stored persistent credential materials that have been replicated to the secondary region. The component works with a customer secrets manager to handle credential data and generate new valid tokens when needed. This dynamic token generation approach offers various advantages, including ensuring token freshness, reducing replication traffic, and maintaining proper security context in the failover region.

An in-memory storage area 912 is used for storing dynamically generated tokens and ephemeral credentials. This volatile memory space plays a useful role in handling credential data during failover events between cloud regions. Instead of directly replicating tokens across regions, the system rebuilds the tokens in the secondary region using persisted credential material. The storage area works with other systems, like secure vaults and database-backed caches, to provide comprehensive credential management. When needed, such as for OAuth access tokens, the system generates new, in-memory tokens using persistent credentials stored in the vault. This approach of separating storage based on credential characteristics and computing short-lived tokens dynamically proves more efficient than direct token replication between regions.

The response path 914 is a system for handling token generation after failover to a secondary cloud region. Rather than replicating short-lived tokens directly, the system stores persistent credential materials in a vault and uses these materials to generate new tokens on-demand when needed. This hybrid approach proves particularly useful for OAuth authentication and per-request tokens. The system fully replicates static credentials while dynamically regenerating ephemeral tokens, optimizing efficiency while maintaining authentication capabilities during failover scenarios.

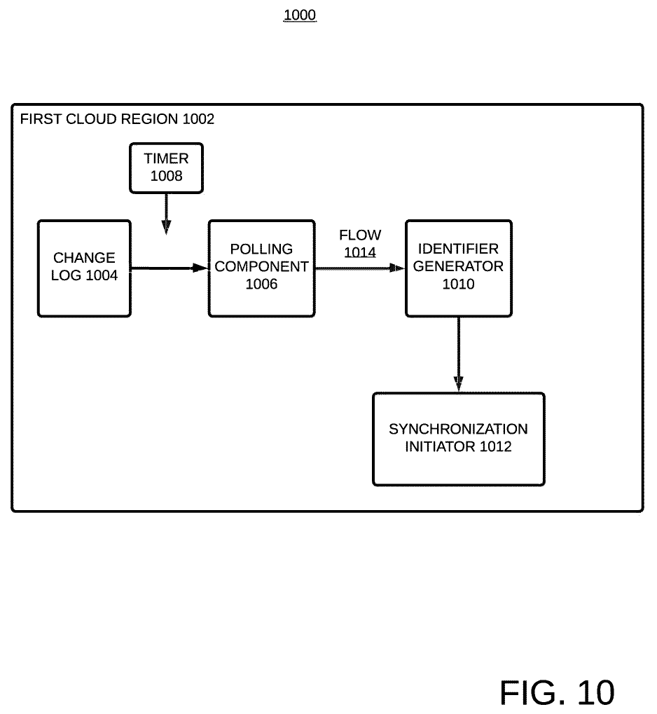

FIG. 10 illustrates a system 1000 for detecting credential data changes through polling a change log and initiating synchronization based on tenant identifiers in a cloud region according to one or more embodiments. The system 1000 represents an extension to the system 100 of FIG. 1. Unless the context clearly indicates otherwise, the system 1000 can be implemented in conjunction with or independently of the other extensions of the system 100 of FIG. 1 disclosed herein.

The system 1000 maintains a change log in the first cloud region to record credential-related operations. The system 1000 polls this change log at defined time intervals to identify any changes made to the credential data. For each change identified during polling, the system 1000 determines an identifier based on the tenant identifier associated with the credential data. After determining the identifier, the system 1000 initiates synchronization of the credential data associated with that computed identifier. This detection and tracking mechanism enables the broader synchronization process between cloud regions described in the parent claim, where credential data undergoes transformation according to the requirements of the second cloud region and resides in corresponding storage systems to enable failover capabilities while maintaining operational continuity for the tenant.

The first cloud region 1002 is a primary cloud computing environment that manages credential data for tenant workloads. The environment features multiple storage systems for different credential types, including hardware secure vaults for static credentials and distributed caches for ephemeral tokens. The region supports multiple tenants per cell in a multi-tenant architecture with shared vault instances. The region maintains a change log for credential operations that is polled for synchronization purposes. The region acts as the source for credential replication to a secondary region, implementing a double-check mechanism to ensure consistency during replication.

The change log 1004 tracks credential operations in the first cloud region as part of a vault replication system. The Change Log 1004 uses a distributed, in-memory, key-value store to maintain records of credential actions, such as creates, updates, and deletes, with multiple updates to the same secret consolidated into a single entry. The system polls the log to identify changes needing replication, using unique identifiers based on tenant ID and connection details. A double-check mechanism ensures consistency during replication with failed transfers returning to the change log. The system supports bi-directional replication in multi-tenant environments, allowing different tenants to have different primary regions while maintaining one-way credential flow from primary to secondary regions.

The polling component 1006 serves as a part of a vault replication system that checks for credential data changes across cloud regions. The component monitors a change log of credential operations in the first cloud region and computes unique identifiers for each change by combining tenant ID and connection details into a hash value. When changes are detected, like OAuth credential updates, the component initiates synchronization with a double-check mechanism to ensure consistency. The component handles different credential types through custom replication logic for vault-stored secrets and native database replication for ephemeral secrets in database-backed caches.

The timer/interval mechanism 1008 operates as a polling system checking for credential data changes to enable cross-region replication. The mechanism works with a change log system to identify credential operations, like updates to usernames/passwords, OAuth tokens, and encryption keys. When changes are detected, the mechanism uses unique identifiers based on tenant ID and connection details to maintain consistency across storage systems and regions. The system guarantees eventual consistency and includes a double-check verification process to ensure accurate replication. If new changes occur during transfer, the credential returns to the cache for the next polling cycle.

The identifier generator 1010 serves as a component in a cloud-based credential replication system that creates unique identifiers for credential changes using tenant information. The generator produces canonical cross-regional identifiers by combining tenant ID, instance ID, and connection details. These identifiers support storage systems to maintain credential integrity between regions. The system operates on a polling cycle for replication, using the generated identifiers to track and synchronize credential changes between primary and secondary regions. This capability proves especially useful in multi-tenant environments to ensure proper isolation and bi-directional replication of credentials between regions while maintaining tenant-specific tracking.

The synchronization initiator 1012 manages credential data replication between cloud regions. The Synchronization Initiator 1012 polls for credential changes using a change log system. When changes are detected, the Synchronization Initiator 1012 initiates synchronization across regions using unique identifiers created from tenant IDs and connection details. The component employs a double-check mechanism to ensure data consistency during replication and supports bi-directional replication while maintaining proper primary-to-secondary region flow for each tenant.

The flow arrow 1014 depicts a polling-based credential data synchronization system across cloud regions. The system operates on a polling interval to detect and replicate credential changes. When credentials are modified in the primary region, changes are logged and tracked. A poller component checks the change log periodically, identifies modified credentials using unique identifiers (combining tenant ID and connection details), and initiates synchronization. The system includes a verification step to ensure no changes occurred during transfer with credentials returning to the change secrets cache if modifications are detected during verification. The process continues until the replicated state matches the latest state, after which the entry is removed from the change log.

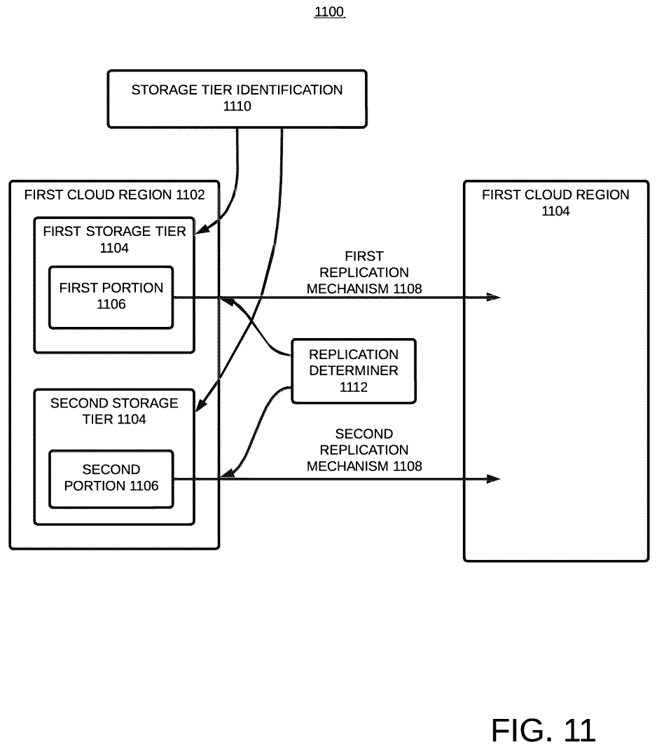

FIG. 11 illustrates a system 1100 for synchronizing credential data across multiple storage tiers using different replication mechanisms between cloud regions according to one or more embodiments. The system 1100 represents an extension to the system 100 of FIG. 1. Unless the context clearly indicates otherwise, the system 1100 can be implemented in conjunction with or independently of the other extensions of the system 100 of FIG. 1 disclosed herein.

The system 1100 synchronizes credential data between cloud regions by implementing tier-specific replication mechanisms. The system 1100 first identifies multiple storage tiers within the first cloud region that include different portions of the credential data. After identifying the storage tiers, the system 1100 determines the specific replication mechanisms associated with each storage tier. The system 1100 then performs the replication process in a tiered manner. The system replicates a first portion of the credential data using a first replication mechanism that corresponds to the first storage tier. Similarly, the system replicates a second portion of the credential data using a second replication mechanism that corresponds to the second storage tier. This tiered approach to replication ensures that each portion of the credential data is synchronized using the most appropriate replication mechanism for the corresponding storage tier while maintaining the overall synchronization process between the first and second cloud regions. The synchronized credential data enables failover capabilities while preserving operational continuity for the tenant.

The cloud regions 1102 include geographically distributed data centers providing disaster recovery through credential data replication between a first and second cloud region. The regions maintain synchronized credential data across different storage tiers with failover capabilities. Examples include paired regions, like Sydney, Australia and Melbourne. Australia, supporting multiple tenants per cell. Different storage systems are used for different credential types—hardware secure vaults for static credentials and distributed caches for ephemeral tokens. The regions use various replication mechanisms, including CDC technology for database-backed caches and custom API-based replication for vaults. Bi-directional synchronization supports multi-tenant scenarios with different primary/secondary region configurations, ensuring credential updates occur in designated primary regions while maintaining eventual consistency.

The storage tiers 1104 is a credential management system that uses different storage tiers to optimize credential storage based on specific needs. Static credentials, like usernames and passwords, are stored in a secure hardware vault, while ephemeral credentials, like access tokens, are kept in distributed caches for frequent updates.

The system implements various replication mechanisms for each tier, using a hybrid synchronization approach. Database-backed cache tiers use native replication technology, while the vault tier uses custom replication logic through APIs for cross-region operations.

The credential management system intelligently distributes different types of credentials across appropriate storage tiers. For example, in OAuth flows, consent tokens go to the vault tier, while access tokens are stored in the cache tier, balancing security and performance requirements.

The first and second credential data portions 1106 represent a system for managing different types of credentials across cloud storage tiers. The system separates credentials into distinct portions based on their characteristics; static credentials (like usernames/passwords) are stored in secure hardware vaults, while ephemeral credentials (like OAuth tokens) are kept in distributed caches. Each portion uses different replication methods—cache-stored credentials use native database replication, while vault-stored credentials use custom API-based replication. The system maintains relationships between credential portions using a canonical cross-regional identifier that combines tenant ID, instance ID, and connection details, ensuring data integrity during replication and failover.

The replication mechanisms 1108 synchronizes credential data across cloud regions using different methods based on storage tiers. For the first tier (ephemeral secrets in database-backed distributed cache), the system uses native database replication like change data capture. For the second tier (vault-stored secrets), the system implements custom API-based replication. The system determines the replication approach based on data storage location-static credentials use vault API-based replication, while dynamic credentials use database replication. This hybrid approach coordinates different mechanisms while maintaining consistency and optimizing for security and performance requirements.

The storage tier identification component 1110 manages and identifies different storage tiers for credential data in cloud regions. The component analyzes various storage systems, including hardware secure vaults, distributed caches, and volatile memory, to determine appropriate replication methods. The component handles different types of credentials based on their characteristics—static credentials, like usernames/passwords, in secure vaults, and ephemeral credentials, like access tokens, in distributed caches. The component uses a hybrid approach, working with database-backed caches using native replication and vault systems requiring custom replication logic. The component collaborates with the secrets manager to track credential segregation across storage tiers and ensures proper synchronization between regions within a service level agreement window.

The replication mechanism determiner 1112 is a component that analyzes storage tiers in cloud infrastructure to determine optimal replication mechanisms for credential data synchronization across regions. The component handles different storage systems uniquely—using native database replication for ephemeral secrets in database-backed caches and custom replication logic for vault-stored secrets. The component bases decisions on storage characteristics and update patterns, storing static credentials in hardware secure vaults, while keeping ephemeral credentials in distributed cache storage. The component implements a hybrid synchronization approach combining native replication capabilities with custom logic where needed. Working with the secrets manager, the component handles complex scenarios, like OAuth flows, by determining appropriate replication mechanisms while maintaining relationships between different credential types.

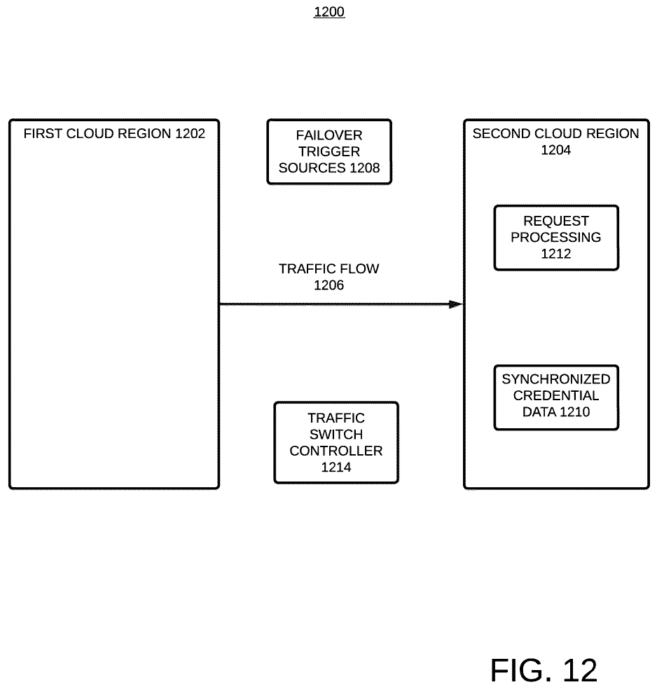

FIG. 12 illustrates a system 1200 for switching network traffic between cloud regions during failover operations using synchronized credential data and request processing according to one or more embodiments. The system 1200 represents an extension to the system 100 of FIG. 1. Unless the context clearly indicates otherwise, the system 1200 can be implemented in conjunction with or independently of the other extensions of the system 100 of FIG. 1 disclosed herein.

The system 1200 enables failover between cloud regions while maintaining operational continuity through a series of coordinated steps. When initiating failover operations from the first cloud region to the second cloud region, the system responds to specific triggers. These triggers include either an explicit user command requesting the failover or the detection of an event that indicates the first cloud region is impaired. Upon detecting either trigger, the system executes the failover process.

During the failover process, the system redirects network traffic from the first cloud region to the second cloud region. This traffic redirection ensures that incoming requests are routed to the operational second cloud region rather than the potentially impaired first cloud region. After completing the traffic switch, the system processes subsequent requests using the previously synchronized credential data residing in the second cloud region. This synchronized credential data, which was earlier transformed to meet the second cloud region's requirements and stored in the corresponding storage systems, enables seamless continuation of operations under the same tenant identifier.

The first cloud region 1202 is a primary cloud computing environment that manages tenant operations and credential data. The region stores different types of credentials in systems, including secure vaults for static credentials and distributed caches for ephemeral tokens. The region acts as the source for credential replication, synchronizing with a secondary region through a change log system. The region operates continuously until failover events occur either through user commands or automated detection of regional issues. The region uses a multi-tenant architecture that allows efficient resource sharing while maintaining strict security isolation between customers with each vault instance capable of serving multiple tenants.

The second cloud region 1204 serves as a failover destination in a disaster recovery system for cloud-based credential management. The region functions as a synchronized backup environment that replicates credential data from the first cloud region, maintaining corresponding storage systems for both static credentials in vault storage and ephemeral tokens in distributed caches. The region becomes active during failover events, triggered either manually or automatically, redirecting network traffic through DNS switching. The region supports bi-directional synchronization with the first region through a polling mechanism, allowing the region to serve as either primary or secondary region while maintaining security in a multi-tenant environment.

The network traffic flow indicator 1206 manages network traffic redirection during cloud region failover operations. The component monitors and switches traffic between primary and secondary cloud regions when failover is triggered by user command or system impairment. Operating within a cloud-based integration platform, the indicator enables seamless disaster recovery through DNS-level switching and works with bi-directional synchronization to maintain business continuity. The indicator supports multi-tenant environments where different tenants can have different primary/secondary region configurations, ensuring appropriate traffic routing based on each tenant's specific setup during both normal operations and failover scenarios.

The failover trigger sources 1208 is a system for managing failover operations between cloud regions in disaster recovery. Two main trigger types exist, explicit user commands for planned failovers and automated event detection for impairment scenarios. The system maintains synchronized credentials across regions, enabling business continuity during failovers. When triggered, the failover process includes DNS switching to redirect traffic to the secondary region, where pre-replicated credentials allow operations to continue uninterrupted.

The synchronized credential data 1210 represents a component in a cloud-based disaster recovery system. The storage manages different types of credentials across multiple storage systems, using secure vaults for static credentials and distributed caches for ephemeral ones. The storage system maintains exact credential replicas across cloud regions to enable seamless failover operations. The storage system uses a hybrid approach, combining native replication capabilities and custom synchronization logic, to ensure credentials are properly synchronized and available during region switches, maintaining business continuity. The storage system specifically handles both static credentials (like usernames/passwords) and dynamic credentials (like OAuth tokens) appropriately based on the credentials' characteristics and update frequencies.

The request processing unit 1212 handles requests during cloud region failovers using synchronized credential data replicated to secondary regions. The request processing unit 1212 maintains business continuity by processing authentication and access requests using both static credentials (usernames/passwords) and dynamic credentials (OAuth tokens) that have been pre-synchronized across regions. Working with DNS traffic switching, the request processing unit 1212 seamlessly handles redirected requests in the secondary region using synchronized vault-stored secrets and cached tokens. The request processing unit 1212 supports eventual consistency for cross-region replication and can compute dynamic credentials on-demand using replicated material rather than directly replicating ephemeral tokens.

The network traffic switch controller 1214 manages network traffic redirection between cloud regions during failover operations. The network traffic switch controller 1214 activates when receiving failover commands or detecting regional impairments, working with DNS-level switching to redirect traffic from impaired primary regions to secondary regions. The network traffic switch controller 1214 ensures business continuity by maintaining synchronized credentials across regions, including static vault credentials, ephemeral tokens, and authentication materials. The network traffic switch controller 1214 supports bi-directional failover capabilities, allowing traffic switching between regions regardless of primary/secondary status, which proves useful for multi-tenant environments with different disaster recovery configurations.

### 3.0 EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

In one or more embodiments, a cloud service provider implements credential data replication across geographic regions to ensure high availability of authentication services. The implementation leverages existing cloud infrastructure, including regional data centers, storage services, and network connectivity between regions.

The cloud service provider maintains distinct credential storage systems within every cloud region. Authentication tokens reside in a REDIS cluster optimized for fast retrieval. Digital certificates occupy an encrypted object store designed for secure certificate management. Encryption keys reside in a hardware security module (HSM) providing FIPS 140-2 Level 3 protection.

A credential management microservice running in the first cloud region processes incoming credential updates from tenants. The microservice validates tenant permissions and parses metadata including the tenant identifier. Based on the credential type, the microservice routes data to the appropriate storage system through standardized APIs. The tenant identifier links to configuration data specifying replication targets in a POSTGRESQL database.

Upon detecting a credential modification, the credential management microservice triggers a replication workflow. The workflow queries tenant configuration to identify target regions requiring synchronized credentials. A transformation service converts credentials to meet regional requirements. The transformation service handles format conversions, such as PEM to DER for certificates or PKCS #1 to PKCS #8 for private keys. Regional security policies may mandate specific encryption algorithms or key lengths, necessitating cryptographic transformations.

The transformed credentials transfer to target regions through encrypted channels using TLS 1.3. A receiving microservice in the target region validates the incoming data and distributes credentials to corresponding storage systems. The receiving microservice maintains a message queue to handle high replication volumes while ensuring ordered processing.

Failover capabilities leverage DNS routing and load balancers. When monitoring detects a regional outage, DNS entries update to direct traffic to the backup region. The synchronized credential stores in the backup region allow authentication services to resume with minimal disruption. Load balancers distribute incoming requests across available authentication nodes in the backup region.

The cloud service provider measures replication performance through latency metrics and consistency checks. Monitoring systems track the time between credential updates and successful replication. Periodic validation ensures credential consistency across regions. The monitoring data helps optimize replication frequency and transformation processes.

### 4. PRACTICAL APPLICATIONS, ADVANTAGES, AND IMPROVEMENTS

In one or more embodiments, the credential replication system enables organizations to maintain robust authentication services across distributed cloud infrastructure. Multi-region credential synchronization supports global operations by allowing users to authenticate from any geographic location while maintaining consistent security policies. The system particularly benefits enterprises operating in regulated industries where regional data residency requirements mandate local storage of authentication data.

The type-based storage architecture improves credential management efficiency. Authentication tokens stored in high-speed, key-value stores enable rapid authentication flows. Digital certificates in encrypted object storage systems maintain PKI security requirements. Hardware security modules protect encryption keys with dedicated cryptographic hardware. The storage systems optimize performance while meeting security standards for different credential types.

Regional transformation capabilities solve compatibility challenges in heterogeneous cloud environments. Organizations can maintain credentials in formats required by specific regional infrastructure without manual conversion processes. The automated transformation removes the need for maintaining duplicate credential sets or complex format translation tables. Security teams can focus on policy management rather than technical format differences between regions.

The failover mechanism provides business continuity during regional outages. Applications continue processing authentication requests through synchronized credential stores in backup regions. The seamless transition prevents authentication failures that could otherwise block user access to critical systems. Organizations achieve higher availability targets for authentication services without building redundant authentication infrastructure in every region.

The replication system reduces operational overhead for security teams. Automated synchronization eliminates manual credential distribution across regions. The tenant-based configuration allows customized replication policies for different business units or applications. Security administrators maintain centralized control while enabling flexible regional deployments.

The storage architecture supports future extensibility through modular design. New credential types can be added by implementing corresponding storage systems without modifying existing components. The transformation service accommodates new regional requirements through pluggable conversion modules. Organizations can adapt the system as authentication technologies and compliance requirements evolve.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In one or more embodiments, a client may be local to and/or remote from a computer network. The client may access the computer network over other computer networks, such as a private network or the Internet. The client may communicate requests to the computer network using a secure communications protocol, such as Hypertext Transfer Protocol Secure (HTTPS). The requests are communicated through an interface, such as a client interface (such as a web browser), a program interface, or an application programming interface (API).

In one or more embodiments, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to a request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In one or more embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In one or more embodiments, a tenant is associated with a tenant ID. An network resource of the multi-tenant computer network is tagged with a tenant ID. A tenant is permitted access to a particular network resource if the tenant and the particular network resources are associated with a same tenant ID.

In one or more embodiments, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, a database implemented by a multi-tenant computer network may be tagged with a tenant ID. Only a tenant associated with the corresponding tenant ID may access data of a particular database. As another example, a entry in a database implemented by a multi-tenant computer network may be tagged with a tenant ID. Only a tenant associated with the corresponding tenant ID may access data of a particular entry. However, the database may be shared by multiple tenants.

In one or more embodiments, a subscription list indicates that tenants have authorization to access that applications. For an application, a list of tenant IDs of tenants authorized to access the application is stored. A tenant is permitted access to a particular application if the tenant ID of the tenant is included in the subscription list corresponding to the particular application.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

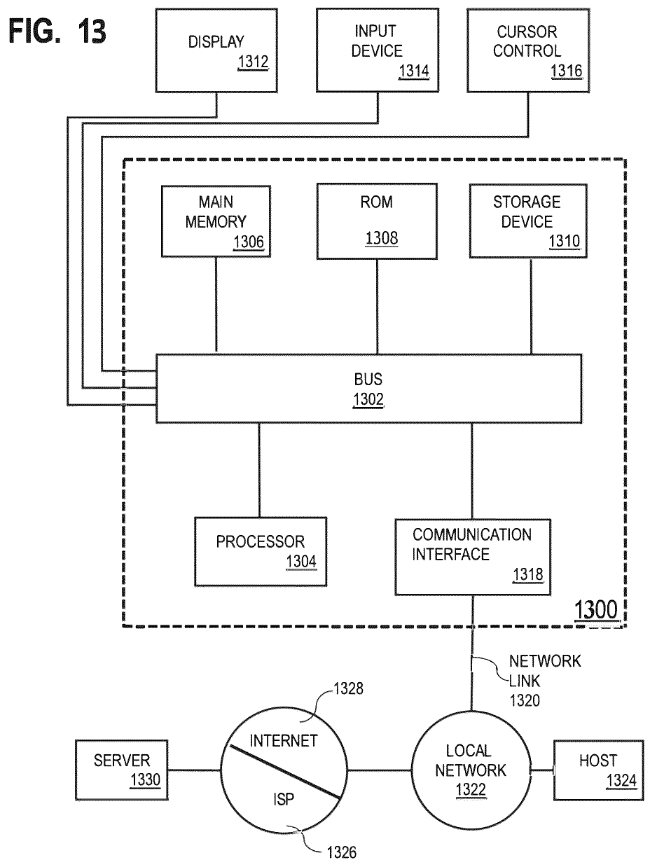

FIG. 13 is a block diagram that illustrates an example computer system 1300 upon which one or more embodiments are implemented. Computer system 1300 includes a bus 1302 or other communication mechanism for communicating information, and a hardware processor 1304 coupled with bus 1302 for processing information. Hardware processor 1304 may be, for example, a general-purpose microprocessor.

Computer system 1300 also includes a main memory 1306, such as a random-access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk, optical disk, or a Solid-State Drive (SSD) is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic that in combination with the computer system causes or programs computer system 1300 to be a special-purpose machine. According to one embodiment, the techniques herein are performed by computer system 1300 based on processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1310. Volatile media includes dynamic memory, such as main memory 1306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid-state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from that processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the worldwide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, that carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

### 7. MISCELLANEOUS; EXTENSIONS

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In one or more embodiments, one or more non-transitory computer readable storage media comprises instructions that, when executed by one or more hardware processors, cause performance of any of the operations described herein and/or recited in any of the claims.

In one or more embodiments, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

1. One or more non-transitory computer-readable media storing instructions which, when executed, cause a set of one or more computer systems to perform a set of operations comprising:
receiving, at a first cloud region, credential data associated with a tenant identifier;
storing the credential data in one or more storage systems of the first cloud region based on at least a type of the credential data;
detecting a change to the credential data in the first cloud region;
wherein the detecting the change is based on at least:
maintaining a change log in the first cloud region that records credential-related operations;
identifying changes to the credential data in the change log;
determining, based on at least the tenant identifier, a second cloud region for replication;
synchronizing the credential data with the second cloud region based on at least retrieving the credential data from the one or more storage systems, and transforming the credential data based on at least requirements of the second cloud region;
storing the transformed credential data in corresponding storage systems of the second cloud region; and
enabling failover to the second cloud region using the synchronized credential data while maintaining continuity of operations associated with the tenant identifier.

2. The one or more non-transitory computer-readable media of claim 1, the set of operations further comprising:
designating a first service instance as a leader service instance in response to the first service instance performing an operation on the credential data; and
storing leader information associated with the first service instance in a database-backed cache that is replicated between the first cloud region and the second cloud region.

3. The one or more non-transitory computer-readable media of claim 1, the set of operations further comprising:
storing static credentials in a hardware secure storage; and
storing ephemeral credentials in a distributed cache optimized for frequent updates.

4. The one or more non-transitory computer-readable media of claim 1, the set of operations further comprising:
detecting an error during synchronization of the credential data;
storing credential data associated with the error in a dead letter queue;
generating an alert for operator intervention in response to storing the credential data in the dead letter queue; and
recovering the credential data from the dead letter queue in response to detecting successful synchronization of a subsequent update to the credential data.

5. A method comprising:
receiving, at a first cloud region, credential data associated with a tenant identifier;
storing the credential data in one or more storage systems of the first cloud region based on at least a type of the credential data;
detecting a change to the credential data in the first cloud region;
determining, based on at least the tenant identifier, a second cloud region for replication;
synchronizing the credential data with the second cloud region based on at least retrieving the credential data from the one or more storage systems, and transforming the credential data based on at least requirements of the second cloud region;
storing the transformed credential data in corresponding storage systems of the second cloud region; and
enabling failover to the second cloud region using the synchronized credential data while maintaining continuity of operations associated with the tenant identifier.

6. The method of claim 5, further comprising:
designating a first service instance as a leader service instance in response to the first service instance performing an operation on the credential data; and
storing leader information associated with the first service instance in a database-backed cache that is replicated between the first cloud region and the second cloud region.

7. The method of claim 5, wherein the storing the credential data in the one or more storage systems is based on at least:
storing static credentials in a hardware secure storage; and
storing ephemeral credentials in a distributed cache optimized for frequent updates.

8. The method of claim 5, further comprising:
detecting an error during synchronization of the credential data;
storing credential data associated with the error in a dead letter queue;
generating an alert for operator intervention in response to storing the credential data in the dead letter queue; and
recovering the credential data from the dead letter queue in response to detecting successful synchronization of a subsequent update to the credential data.

9. The method of claim 5, wherein the detecting the change to the credential data is based on at least:
maintaining a list of changed credentials using a distributed cache system;
identifying changes for synchronization in the list; and
verifying, after initiating synchronization of identified changes, that no additional changes occurred during synchronization based on at least:
taking a snapshot of a current state of the credential data,
comparing the snapshot to a state of the synchronized credential data, and
returning the credential data to the list for another synchronization attempt when the states do not match.

10. The method of claim 5, wherein:
the first cloud region comprises a shared data storage instance serving multiple tenants;
each tenant of the multiple tenants is associated with a primary region and a secondary region;
credential updates for each tenant are restricted to occur in their respective primary region; and
bi-directional synchronization between the first cloud region and the second cloud region is enabled by different tenants having different primary regions.

11. The method of claim 5, wherein:
the storing the credential data is based on at least:
storing static credentials in a hardware secure storage,
storing ephemeral credentials in a database-backed distributed cache, and
storing in-memory credentials in volatile memory; and
the synchronizing the credential data is based on at least:
replicating the static credentials using hardware secure storage application programming interfaces (APIs),
replicating the ephemeral credentials using database replication technology, and
rebuilding the in-memory credentials in the second cloud region based on at least the replicated static and ephemeral credentials.

12. The method of claim 5, wherein the storing the credential data is based on at least:
determining a first type of authentication token having a first set of characteristics and a second type of authentication token having a second set of characteristics from the credential data;
storing the first type of authentication token in a secure hardware storage based on at least the first set of characteristics indicating infrequent updates; and
storing the second type of authentication token in a distributed cache based on at least the second set of characteristics indicating frequent updates.

13. The method of claim 5, wherein the synchronizing the credential data is based on at least:
storing persistent credential material in the second cloud region;
receiving, after failover to the second cloud region, a request requiring a token;
generating, in response to the request, an in-memory token using the stored persistent credential material; and
providing the generated in-memory token to service the request.

14. The method of claim 5, wherein the detecting the change is based on at least:
maintaining a change log in the first cloud region that records credential-related operations;
identifying changes to the credential data in the change log;
determining an identifier for each identified change based on at least the tenant identifier; and
initiating synchronization of the credential data associated with the determined identifier.

15. The method of claim 5, wherein the synchronizing the credential data is based on at least:
identifying multiple storage tiers storing portions of the credential data in the first cloud region;
determining replication mechanisms associated with each storage tier;
replicating a first portion of the credential data using a first replication mechanism associated with a first storage tier; and
replicating a second portion of the credential data using a second replication mechanism associated with a second storage tier.

16. The method of claim 5, wherein the enabling failover is based on at least:
initiating the failover of operations from the first cloud region to the second cloud region in response to at least one of: receiving a user command requesting the failover, or detecting an event indicating impairment of the first cloud region;
switching network traffic from the first cloud region to the second cloud region; and
processing subsequent requests using the synchronized credential data in the second cloud region.

17. A system comprising:
a set of one or more computer systems having one or more hardware processors; and
a set of instructions which, when executed, cause the set of one or more computer systems to perform a set of operations comprising:
receiving, at a first cloud region, credential data associated with a tenant identifier, wherein the first cloud region comprises a shared data storage instance serving multiple tenants, wherein each tenant of the multiple tenants is associated with a respective primary region and a respective secondary region, and wherein credential updates for each tenant are restricted to occur in their respective primary region;
storing the credential data in one or more storage systems of the first cloud region based on at least a type of the credential data;
detecting a change to the credential data in the first cloud region;
determining, based on at least the tenant identifier, a second cloud region for replication;
synchronizing the credential data with the second cloud region based on at least retrieving the credential data from the one or more storage systems, and transforming the credential data based on at least requirements of the second cloud region;
storing the transformed credential data in corresponding storage systems of the second cloud region; and
enabling failover to the second cloud region using the synchronized credential data while maintaining continuity of operations associated with the tenant identifier.

18. The system of claim 17, the set of operations further comprising:
maintaining a list of changed credentials using a distributed cache system;
identifying changes for synchronization in the list; and
verifying, after initiating synchronization of identified changes, that no additional changes occurred during synchronization based on at least:
taking a snapshot of a current state of the credential data,
comparing the snapshot to a state of the synchronized credential data, and
returning the credential data to the list for another synchronization attempt when the states do not match.

19. The system of claim 17, the set of operations further comprising:
storing static credentials in a hardware secure storage,
storing ephemeral credentials in a database-backed distributed cache, and
storing in-memory credentials in volatile memory;
replicating the static credentials using hardware secure storage application programming interfaces (APIs);
replicating the ephemeral credentials using database replication technology; and
rebuilding the in-memory credentials in the second cloud region based on at least the replicated static and ephemeral credentials.

20. The system of claim 17, the set of operations further comprising:
determining a first type of authentication token having a first set of characteristics and a second type of authentication token having a second set of characteristics from the credential data;
storing the first type of authentication token in a secure hardware storage based on at least the first set of characteristics indicating infrequent updates; and
storing the second type of authentication token in a distributed cache based on at least the second set of characteristics indicating frequent updates.
